(19) United States
(12) Patent Application Publication
(10) Pub. No.: US 2023/0294170 A1
(43) Pub. Date: Sep. 21, 2023

(54) 3D PRINTING APPARATUS

(71) Applicant: Mitsubishi Electric Corporation, Tokyo (JP)

(72) Inventors: Shigeru TAKUSHIMA, Tokyo (JP); Daiji MORITA, Tokyo (JP)

(73) Assignee: Mitsubishi Electric Corporation, Tokyo (JP)

(21) Appl. No.: 18/022,175

(22) PCT Filed: Aug. 26, 2020
(86) PCT No.: PCT/JP2020/032170

§ 371 Date: Feb. 20, 2023

(51) Int. Cl. B22F 10/22; B22F 12/44; B22F 10/85

(52) U.S. Cl. CPC B22F 10/22; B22F 12/44; B22F 10/85; B23K 26/342

(57) ABSTRACT

A 3D printing apparatus includes: a machining optical system including an objective lens, and configured to radiate machining light to a machining position; a measurement illumination unit that supplies illumination light for measuring a size of an object formed; a light-receiving element that detects reflected light that is the illumination light reflected by the object; a light-receiving optical system that concentrates the reflected light on the light-receiving element; a calculation unit that computes, through calculation using a detection result of the reflected light in the light-receiving element, a width of the object in a third direction perpendicular to a first direction in which the machining position is moved with respect to a workpiece and a second direction in which beads are stacked; and a control unit that controls a machining condition for forming the beads based on a computation result of the width of the object.

### FIELD

The present disclosure relates to a 3D printing apparatus that forms an object by adding machining material to a workpiece.

### BACKGROUND

Known three-dimensional (3D) printing apparatuses such as 3D printers use a technique called additive manufacturing (AM) that forms a three-dimensional object by adding machining material. Direct energy deposition (DED) is one of multiple types of additive manufacturing methods, in which the 3D printing apparatus supplies wire or powder as machining material to a machining position, melts the machining material with a laser beam or the like, and stacks beads on a workpiece to form an object. Beads are solidified products of the machining material melted.

The 3D printing apparatus forms an object by continuously adding machining material along a predetermined path, but the formed shape may be different from the designed desired shape. In one example, the width of the portion formed a certain period of time after the start of creation may be different from the width of the portion formed at the start of creation, which can affect the shape of the object. At the start of creation, the temperature of the workpiece and the object on the workpiece is low, but as the creation progresses, the heat storage of the object increases and accordingly the temperature of the object increases. As the temperature of the object increases, the height of the formed beads decreases and the bead width increases. Changes in bead width due to heat storage vary depending on the machining conditions, machining material, machining shape, and the like; therefore, it is difficult to predict changes in bead width in advance and optimize the machining program.

Patent Literature 1, which relates to a welding apparatus that performs arc welding, discloses that an optical sensor is installed at a certain distance ahead of the welding torch to capture the cross-sectional shape of a formed bead so as to measure the bead width. The welding apparatus according to Patent Literature 1 computes the amount of correction of the torch position based on the measurement value from the optical sensor, and corrects the position of the welding torch so as to offset the torch displacement. According to the technique of Patent Literature 1, it is possible to measure, at a position ahead of the machining position during the measurement, the bead width in the layer immediately below the layer being machined during the measurement.

### CITATION LIST

### Patent Literature

Patent Literature 1: Japanese Patent Application Laid-open No. 2002-144035

### SUMMARY

### Technical Problem

According to the conventional technique disclosed in Patent Literature 1, the optical sensor is a component separate from the welding torch, and is installed at a position away from the welding torch by a certain distance. Therefore, the bead width is measured at a position away from the machining position. The farther the measurement position is from the machining position, the more difficult it is to perform control for obtaining an object with high shape accuracy. In addition, at the measurement position far from the machining position, it may or may not be possible to measure the bead width depending on the shape of the object. Thus, the conventional technique is problematic in that it is difficult to form an object with high shape accuracy because the bead width cannot be measured at a position as close as possible to the machining position.

The present disclosure has been made in view of the above, and an object thereof is to obtain a 3D printing apparatus capable of forming an object with high shape accuracy.

### Solution to Problem

In order to solve the above-described problems and achieve the object, a 3D printing apparatus according to the present disclosure forms an object by radiating machining light to a machining material supplied to a machining position to melt the machining material, and stacking, on a workpiece, beads that are solidified products of the machining material melted. The 3D printing apparatus according to the present disclosure includes: a machining optical system including an objective lens through which the machining light passes, and configured to radiate the machining light to the machining position; a measurement illumination unit that supplies illumination light for measuring a size of the object formed; a light-receiving element that detects reflected light that is the illumination light reflected by the object; a light-receiving optical system that concentrates the reflected light on the light-receiving element; a calculation unit that computes, through calculation using a detection result of the reflected light in the light-receiving element, a width of the object in a third direction perpendicular to a first direction in which the machining position is moved with respect to the workpiece and a second direction in which the beads are stacked; and a control unit that controls a machining condition for forming the beads based on a computation result of the width of the object. The objective lens constituting the machining optical system also serves as an objective lens constituting the light-receiving optical system or an objective lens that radiates the illumination light from the measurement illumination unit to the object.

### Advantageous Effects of Invention

The 3D printing apparatus according to the present disclosure can achieve the effect of forming an object with high shape accuracy.

### BRIEF DESCRIPTION OF DRAWINGS

FIG. 1 is a perspective diagram illustrating a configuration of a 3D printing apparatus according to a first embodiment.

FIG. 2 is a diagram illustrating an example of a control circuit for implementing the functions of the calculation unit and the control unit of the 3D printing apparatus according to the first embodiment.

FIG. 3 is a diagram illustrating the machining optical system and the light-receiving optical system of the 3D printing apparatus according to the first embodiment.

FIG. 4 is a flowchart illustrating an operation procedure for forming an object with the 3D printing apparatus according to the first embodiment.

FIG. 5 is a first diagram illustrating machining with the 3D printing apparatus according to the first embodiment.

FIG. 6 is a second diagram illustrating machining with the 3D printing apparatus according to the first embodiment.

FIG. 7 is a diagram illustrating an example of an image of a line beam formed on the light-receiving element in the first embodiment.

FIG. 8 is a diagram for explaining a first example of computing the width of an object from the measurement result of the cross-sectional height distribution of the object in the first embodiment.

FIG. 9 is a diagram for explaining a second example of computing the width of an object from the measurement result of the cross-sectional height distribution of the object in the first embodiment.

FIG. 10 is a flowchart illustrating a procedure for controlling the bead width through machining condition control in the first embodiment.

FIG. 11 is a diagram for explaining machining control that is based on the measurement result of the width of the object in the first embodiment.

FIG. 12 is a flowchart illustrating a procedure for restoring a three-dimensional shape based on the measurement results of bead width and bead height in the first embodiment.

FIG. 13 is a perspective diagram illustrating a configuration of a 3D printing apparatus according to a modification of the first embodiment.

FIG. 14 is a diagram illustrating line beams for use in measuring the width of an object in the modification of the first embodiment.

FIG. 15 is a diagram illustrating a modification of a line beam in the first embodiment.

FIG. 16 is a diagram illustrating a first modification of the optical systems of the 3D printing apparatus according to the first embodiment.

FIG. 17 is a diagram illustrating a second modification of the optical systems of the 3D printing apparatus according to the first embodiment.

FIG. 18 is a flowchart illustrating an operation procedure for forming a ball bead with a 3D printing apparatus according to a second embodiment.

FIG. 19 is a schematic cross-sectional diagram illustrating a machining area of the 3D printing apparatus according to the second embodiment.

FIG. 20 is a schematic cross-sectional diagram in which the wire fed to the machining area of the 3D printing apparatus according to the second embodiment is in contact with the surface to be machined.

FIG. 21 is a schematic cross-sectional diagram in which a beam is radiated to the machining area of the 3D printing apparatus according to the second embodiment.

FIG. 22 is a schematic cross-sectional diagram in which the supply of wire to the machining area of the 3D printing apparatus according to the second embodiment is started.

FIG. 23 is a schematic cross-sectional diagram in which the wire is pulled out from the machining area of the 3D printing apparatus according to the second embodiment.

FIG. 24 is a schematic cross-sectional diagram in which the radiation of the beam to the machining area of the 3D printing apparatus according to the second embodiment is stopped.

FIG. 25 is a schematic cross-sectional diagram in which the machining head of the 3D printing apparatus according to the second embodiment moves to the next machining point.

FIG. 26 is a schematic cross-sectional diagram for explaining a method of creating an object with the 3D printing apparatus according to the second embodiment.

FIG. 27 is a flowchart for explaining a procedure in which the 3D printing apparatus according to the second embodiment performs the additive machining of a ball bead using the measurement result of the width of the already-formed object.

FIG. 28 is a first diagram illustrating an example of an object formed with a 3D printing apparatus according to a third embodiment.

FIG. 29 is a second diagram illustrating an example of an object formed with the 3D printing apparatus according to the third embodiment.

FIG. 30 is a flowchart illustrating a procedure for computing the width of an object with the 3D printing apparatus according to the third embodiment.

FIG. 31 is a flowchart illustrating a procedure for computing the width of an object with the 3D printing apparatus according to the third embodiment.

FIG. 32 is a first diagram for explaining the measurement of the width of an object in the third embodiment.

FIG. 33 is a second diagram for explaining the measurement of the width of an object in the third embodiment.

FIG. 34 is a diagram for explaining an example of computing the width of an object from the measurement result of the cross-sectional height distribution of the object in the third embodiment.

FIG. 35 is a first diagram for explaining the measurement of the width of an object at the time of creating the last row in one layer in the third embodiment.

FIG. 36 is a second diagram for explaining the measurement of the width of an object at the time of creating the last row in one layer in the third embodiment.

### DESCRIPTION OF EMBODIMENTS

Hereinafter, a 3D printing apparatus according to embodiments will be described in detail based on the drawings.

### First Embodiment

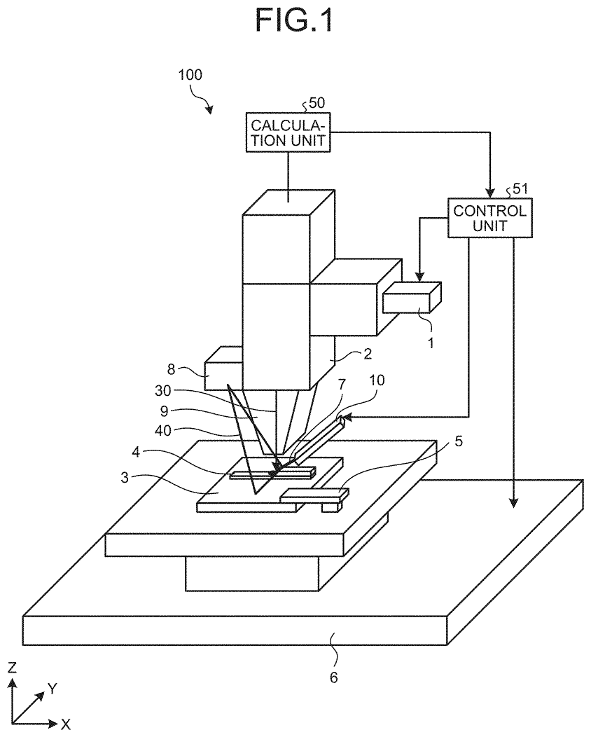

FIG. 1 is a perspective diagram illustrating a configuration of a 3D printing apparatus 100 according to the first embodiment. The 3D printing apparatus 100 forms an object by radiating machining light to a machining material supplied to a machining position to melt the machining material, and stacking, on a workpiece, beads that are solidified products of the machining material melted.

In the first embodiment and in the second and subsequent embodiments, the 3D printing apparatus 100 is a metal deposition apparatus that uses metal as a machining material. The 3D printing apparatus 100 may use a non-metal machining material such as resin. In the following description, an object that is formed by the 3D printing apparatus 100 may also be referred to as a deposit. The 3D printing apparatus 100 performs the additive machining of melting machining material using a machining laser and adding the machining material to the target surface of the workpiece. The 3D printing apparatus 100 may use another machining method such as arc discharge.

The 3D printing apparatus 100 repeats the additive machining of melting a machining material 7 and adding molten machining material onto a workpiece 3, thereby forming an object 4. The 3D printing apparatus 100 measures the cross-sectional height distribution of the object 4 formed at the same time as the formation of the object 4, and computes the bead width based on the measurement result. The 3D printing apparatus 100 has a function of controlling machining conditions for the next additive machining based on the computation result of the bead width. In the first additive machining after starting the formation of the object 4, the 3D printing apparatus 100 places the melted machining material 7 on the workpiece 3 and forms a bead layer on the workpiece 3. The 3D printing apparatus 100 forms the object 4 by stacking new bead layers on the formed bead layer.

The 3D printing apparatus 100 includes a machining laser 1, a machining head 2, a fixture 5 for fixing the workpiece 3, a drive stage 6, a measurement illumination unit 8, a gas nozzle 9, a machining material supply unit 10, a calculation unit 50, and a control unit 51.

The machining laser 1 is a light source that emits a laser beam that is machining light. Hereinafter, a laser beam emitted from the machining laser 1 is referred to as a beam 30. The machining laser 1 is a fiber laser device using a semiconductor laser, a CO₂ laser device, or the like. The wavelength of the beam 30 is, for example, 1070 nm.

The machining head 2 includes a machining optical system and a light-receiving optical system. The machining optical system radiates the beam 30 to the machining position. The machining optical system concentrates the beam 30 emitted from the machining laser 1 and focuses the beam 30 on the machining position on the workpiece 3. Generally, the beam 30 is concentrated in a point shape on the machining position. The machining laser 1 and the machining optical system constitute a machining unit. In the first embodiment, the light-receiving optical system is located in the machining head 2 and integrated with the machining optical system.

The workpiece 3 is placed on the drive stage 6 and fixed on the drive stage 6 by the fixture 5. The workpiece 3 is a base on which the object 4 is formed. Here, the workpiece 3 is a base plate, but may be an object with a three-dimensional shape. A surface of the workpiece 3 on which a bead is formed or a surface of an already-formed portion of the object 4 on which a bead is formed is referred to as a surface to be machined.

As the drive stage 6 moves, the position of the workpiece 3 with respect to the machining head 2 changes, and the machining position moves on the workpiece 3. The machining position moves along a predetermined path, specifically, so as to draw a predetermined trajectory, on the workpiece 3. Note that the movement of the machining position involves movement in a direction orthogonal to the height direction of the object 4. Specifically, the machining position before the movement and the machining position after the movement differ in the position projected on the plane orthogonal to the height direction. The 3D printing apparatus 100 supplies the machining material 7 to the machining position while scanning the workpiece 3 with the beam 30 concentrated on the machining position.

The drive stage 6 is movable in the directions of three axes of X, Y, and Z. The Z direction is the direction in which bead layers are stacked, which is the height direction of the object 4. The X direction is a direction perpendicular to the Z direction. The machining material supply unit 10 that supplies the machining material 7 is installed at a position in the X direction as viewed from the machining head 2. The Y direction is the direction perpendicular to each of the X direction and the Z direction. The drive stage 6 can translate in the direction of any one of the three axes of X, Y, and Z. Note that the direction indicated by the X-directional arrow in the drawing is referred to as the +X direction, and the direction opposite to the +X direction is referred to as the −X direction. The direction indicated by the Y-directional arrow in the drawing is referred to as the +Y direction, and the direction opposite to the +Y direction is referred to as the −Y direction. The direction indicated by the Z-directional arrow in the drawing is referred to as the +Z direction, and the direction opposite to the +Z direction is referred to as the −Z direction.

The drive stage 6 may be a five-axis stage rotatable in the XY plane and rotatable in the YZ plane. With the drive stage 6 rotatable, the 3D printing apparatus 100 can change the posture or position of the workpiece 3. By rotating the drive stage 6, the 3D printing apparatus 100 can move the irradiation position of the beam 30 with respect to the workpiece 3. By moving the irradiation position, the 3D printing apparatus 100 can form complicated shapes including a tapered shape. The 3D printing apparatus 100 described herein is configured to move the machining position using the drive stage 6 that can be driven in five axes, but the machining position may be moved by driving the machining head 2.

The 3D printing apparatus 100 supplies the machining material 7 to the machining position while scanning the workpiece 3 by driving the drive stage 6. The 3D printing apparatus 100 performs additive machining by stacking the melted machining material 7 at the machining position that moves on the workpiece 3. More specifically, the 3D printing apparatus 100 moves candidate points for the machining position on the workpiece 3 by driving the drive stage 6. At least one of the candidate points on the movement path is the machining position. The machining position is moved while the machining material 7 is supplied to the machining position and the machining material 7 is melted, whereby a bead is formed.

In this manner, a new bead is deposited each time the machining position moves, whereby a part of the object 4 is newly formed. Beads are repeatedly deposited, and the object 4 having a desired shape is formed as a final product. Note that in the first embodiment, a bead is defined as a just-solidified solid of the melted machining material 7, which is distinguished from the object 4 defined as a solid formed by a solidified bead(s).

An example of the machining material 7 is metal wire or metal powder. The machining material 7 is hereinafter discussed as metal wire. The machining material 7 is supplied from the machining material supply unit 10 to the machining position. For example, the machining material supply unit 10 rotates the wire spool with the metal wire wound therearound as the rotary motor is driven, thereby feeding the metal wire to the machining position. The machining material supply unit 10 drives the rotary motor in the direction opposite to the direction in which the metal wire is fed, thereby pulling the fed metal wire back toward the wire spool. The machining material supply unit 10 is installed integrally with the machining head 2. As the drive stage 6 moves, the position of the workpiece 3 with respect to the machining head 2 and the machining material supply unit 10 changes. Note that the method of supplying metal wire is not limited to the above example.

In the first embodiment, the measurement illumination unit 8 is attached to a side surface of the machining head 2. The measurement illumination unit 8 irradiates the object 4 with illumination light for measuring the size of the object 4 formed on the workpiece 3. In order to measure the cross-sectional height distribution of the already-formed object 4, the measurement illumination unit 8 radiates illumination light toward a measurement position on the workpiece 3 or on the formed object 4. The measurement position moves as the machining position moves. In the case where the measurement position is a position on the object 4, the measurement position is a position where the melted machining material 7 has already solidified. In the first embodiment, illumination light is a line beam 40 radiated linearly. The measurement position is a position where illumination light is reflected. The measurement position is desirably as close as possible to the machining position.

The light-receiving optical system concentrates the reflected light, i.e. illumination light reflected by the object 4, on a light-receiving element. The light-receiving optical system is located inside the machining head 2 so as to receive the reflected light from the measurement position. The light-receiving optical system is located so as to have an optical axis inclined with respect to the optical axis of the line beam 40. Because the peak wavelength of thermal radiation light that is generated during machining is infrared, it is desirable to use a green laser having a wavelength of about 550 nm or a blue laser having a wavelength of about 420 nm, which is away from the peak wavelength of thermal radiation light, for the light source of the measurement illumination unit 8.

The gas nozzle 9 ejects, toward the workpiece 3, a shield gas for preventing oxidation of the object 4 and cooling beads. In the first embodiment, the shield gas is an inert gas. The gas nozzle 9 is attached to the lower part of the machining head 2 and is installed above the machining position. In the first embodiment, the gas nozzle 9 is installed coaxially with the beam 30, but the gas may be ejected toward the machining position in a direction oblique to the Z axis.

The calculation unit 50 calculates the cross-sectional height distribution of the object 4 at the machining position, and computes the width of the object 4 using the cross-sectional height distribution. The calculation unit 50 calculates the cross-sectional height distribution of the object 4 at the machining position using the principle of triangulation based on the light-receiving position of the reflected light of the line beam 40, which will be described in detail later. The term “light-receiving position” as used herein is the position of the line beam 40 on the light-receiving element.

The control unit 51 controls machining conditions for forming beads based on the computation result of the width of the object 4. The control unit 51 uses the width of the object 4 computed by the calculation unit 50 to control machining conditions, examples of which include driving conditions for the machining laser 1, driving conditions for the machining material supply unit 10 that supplies the machining material 7, and driving conditions for the drive stage 6. The driving conditions for the machining material supply unit 10 include conditions related to the height at which the machining material 7 is supplied. The measurement illumination unit 8, the light-receiving optical system, and the calculation unit 50 are collectively referred to as a height measurement unit.

Next, the hardware configuration of the calculation unit 50 and the control unit 51 will be described. The functions of the calculation unit 50 and the control unit 51 are implemented by processing circuitry that is an electronic circuit that performs each process. The processing circuitry may be dedicated hardware or may be a control circuit using a central processing unit (CPU) that executes a program.

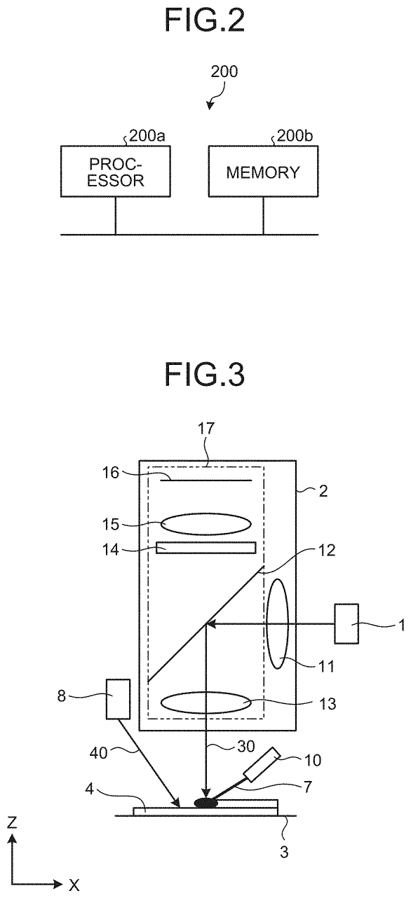

FIG. 2 is a diagram illustrating an example of a control circuit 200 for implementing the functions of the calculation unit 50 and the control unit 51 of the 3D printing apparatus 100 according to the first embodiment. The control circuit 200 includes a processor 200a and a memory 200b. The processor 200a is a CPU, and is also called a central processing device, a processing device, an arithmetic device, a microprocessor, a microcomputer, a digital signal processor (DSP), or the like.

Programs that are executed by the processor 200a are stored in the memory 200b. Examples of the memory 200b include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

The processor 200a reads the program corresponding to each process from the memory 200b and executes the read program. The functions of the calculation unit 50 and the control unit 51 are implemented by the processor 200a executing the programs. The memory 200b is also used as a temporary memory for each process performed by the processor 200a.

FIG. 3 is a diagram illustrating the machining optical system and the light-receiving optical system of the 3D printing apparatus 100 according to the first embodiment. The machining head 2 includes a light-projecting lens 11, a beam splitter 12, an objective lens 13, a bandpass filter 14, a condenser lens 15, and a light receiver 16.

The beam 30 emitted from the machining laser 1 passes through the light-projecting lens 11 and enters the beam splitter 12. The beam 30 is reflected by the beam splitter 12 toward the workpiece 3. The beam 30 reflected by the beam splitter 12 is concentrated on the machining position on the workpiece 3 by the objective lens 13. The light-projecting lens 11, the beam splitter 12, and the objective lens 13 constitute the machining optical system provided in the machining head 2. For example, the focal length of the light-projecting lens 11 is 200 mm, and the focal length of the objective lens 13 is 460 mm. The surface of the beam splitter 12 is coated so as to increase the reflectance at the wavelength of the beam 30 incident from the machining laser 1 and transmit light having a wavelength shorter than the wavelength of the beam 30.

FIG. 3 shows a state in which the machining material 7 is supplied to the machining position while the workpiece 3 is moved in the +X direction by the drive of the drive stage 6. In FIG. 3, the machining material 7 is supplied from the +X direction toward the −X direction. The machining position moves in the −X direction with respect to the workpiece 3. At the machining position, the machining material 7 is melted by the beam 30, and the melted machining material 7 is added to the already-formed object 4. As the machining position moves from the position where the melted machining material 7 has been added, and the machining material 7 added to the object 4 solidifies, a bead is formed extending in the −X direction. In the first embodiment, the 3D printing apparatus 100 forms a line bead, i.e. a bead having a linear shape. The bead width is the width of the bead in the direction perpendicular to the direction in which the machining position moves and parallel to the surface to be machined. The height of a bead is the height of the bead in the height direction of the object 4.

The measurement illumination unit 8 radiates the line beam 40 toward the measurement position. The measurement position is determined in consideration of the direction in which the machining material 7 is supplied or the like. For example, the measurement position is set on the side opposite to the location of the machining material supply unit 10, which is the supply source of the machining material 7, relative to the machining position. This prevents the line beam 40 from being blocked by the machining material 7, which facilitates the irradiation of the measurement position with the line beam 40.

The line beam 40 is a line-shaped beam perpendicular to the direction in which a bead is formed. In the example illustrated in FIG. 3, the line beam 40 is a line-shaped beam extending in the Y direction perpendicular to the X direction in which a bead is formed and parallel to the upper surface of the drive stage 6. The line beam 40 is formed using an optical element such as a cylindrical lens. The line beam 40 may be formed by fast scanning of the laser spot by using a drive device such as a micro electro mechanical systems (MEMS) mirror. The object 4 is irradiated with the line-shaped line beam 40 crossing the object 4. The reflected light that is the line beam 40 reflected at the measurement position enters the objective lens 13. After passing through the objective lens 13, the reflected light passes through the beam splitter 12 and the bandpass filter 14, and enters the condenser lens 15. The reflected light is concentrated on the light receiver 16 by the condenser lens 15. The light receiver 16 includes the light-receiving element. On the light-receiving element, an image of the line beam 40 at the measurement position is formed.

The objective lens 13 and the condenser lens 15 are collectively referred to as the light-receiving optical system. The light-receiving optical system includes, for example, two lenses which are the objective lens 13 and the condenser lens 15. The light-receiving optical system may have a configuration in which three or more lenses are used, e.g. a configuration in which the condenser lens 15 consists of two lenses: a convex lens and a concave lens. The light-receiving optical system only needs to have a function of forming an image on the light receiver 16. The light receiver 16 can be an area camera or the like equipped with a light-receiving element such as a complementary metal oxide semiconductor (CMOS) image sensor, but only needs to include a light-receiving element in which pixels are arranged two-dimensionally. Note that it is desirable that the bandpass filter 14 that transmits only the irradiation wavelength of the line beam 40 be placed in the optical system from the beam splitter 12 to the light receiver 16. By providing the bandpass filter 14, it is possible to remove light having an unnecessary wavelength among machining light, thermal radiation light, ambient light, and the like. The light-receiving optical system and the light-receiving element are collectively referred to as a light-receiving unit 17. In the first embodiment, the objective lens 13 constituting the machining optical system also serves as the objective lens 13 constituting the light-receiving optical system. That is, in the 3D printing apparatus 100, the objective lens 13 is shared by the light-receiving optical system and the machining optical system.

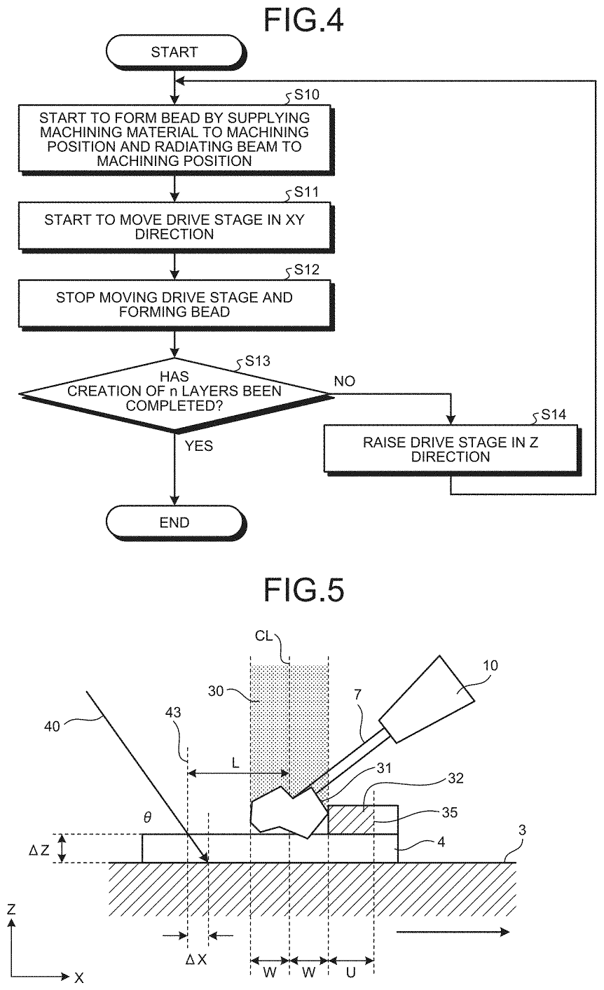

FIG. 4 is a flowchart illustrating an operation procedure for forming the object 4 with the 3D printing apparatus 100 according to the first embodiment. Here, the 3D printing apparatus 100 forms the object 4 by stacking n layers each including a bead. Here, n is an integer of two or more.

In step S10, the 3D printing apparatus 100 starts to form a bead by supplying the machining material 7 to the machining position and radiating the beam 30 to the machining position. In step S11, the 3D printing apparatus 100 starts to move the drive stage 6 in the XY direction. The formation of a bead in step S10 and the movement of the drive stage 6 in step S11 are simultaneously started. The formation of a bead and the movement of the drive stage 6 may be started in sequential order. Consequently, the melted machining material 7 solidifies to form the bead extending along the trajectory of the machining position. In the case where the drive stage 6 moves in the +X direction as illustrated in FIG. 3, the bead is formed extending in the −X direction. The formed bead is a part of the object 4.

Once the movement of the machining position in the set path is completed, the 3D printing apparatus 100 stops moving the drive stage 6 and forming the bead in step S12. The 3D printing apparatus 100 stops forming the bead by stopping the irradiation with the beam 30 and the supply of the machining material 7.

In step S13, the 3D printing apparatus 100 determines whether the creation of the n layers has been completed. In response to determining that the creation of the n layers has not been completed (step S13: No), the 3D printing apparatus 100 raises the drive stage 6 in the Z direction in step S14. Thereafter, the 3D printing apparatus 100 returns the procedure to step S10 to start creating the next layer. The 3D printing apparatus 100 repeats the procedure of steps S10 to S14 until the creation of the n layers is completed.

On the other hand, in response to determining that the creation of the n layers has been completed (step S13: Yes), the 3D printing apparatus 100 ends the formation of the object 4 with the procedure illustrated in FIG. 4. In this manner, the 3D printing apparatus 100 forms new parts of the object 4 by stacking new beads on the workpiece 3 or on the formed object 4. The 3D printing apparatus 100 forms the object 4 that is a final product having a desired shape by creating all the n layers.

Note that in FIG. 3, the direction in which the drive stage 6 is moved is the +X direction, and the machining direction in which beads are formed is the −X direction. Alternatively, the direction in which the drive stage 6 is moved may be the −X direction, and the direction in which beads are formed may be the +X direction. The direction in which the drive stage 6 is moved and the direction in which beads are formed may be the Y direction. In addition, the drive stage 6 may be moved simultaneously in the X direction and the Y direction, and the direction in which beads are formed may be an oblique direction between the X direction and the Y direction. In any case, the measurement illumination unit 8 is installed such that the line beam 40 crosses the formed beads.

It is desirable that the object 4 be formed with the width as designed, but the width of the object 4 formed may deviate from the width as designed due to the conditions of additive machining or continuous creation. The conditions of additive machining include the machining material 7, the shape of the surface to be machined, the trajectory of 3D printing, the output of the machining laser 1, the supply speed of the machining material 7, the moving speed of the drive stage 6, and the like. In the following description, the moving speed of the drive stage 6 may be referred to as the scanning speed of the machining position. The high-output machining laser 1 heats the machining position to such an extent that the metal material melts. Therefore, the temperature of the surface to be machined differs between the first layer formed first and the layer formed after the drive stage 6 is raised multiple times.

In general, as the 3D printing progresses, the heat storage of the object 4 increases and accordingly the temperature of the surface to be machined becomes high. As the temperature of the surface to be machined becomes high, the height of the formed beads decreases and the bead width increases. Thus, the width of the object 4 formed increases as the creation progresses in the +Z direction. Changes in bead width due to heat storage vary depending on the machining conditions, the machining material 7, the machining shape, and the like; therefore, it is difficult to set in advance the machining conditions for making the bead width uniform.

In the first embodiment, the 3D printing apparatus 100 measures the width of the already-formed object 4, and optimally controls machining conditions according to the difference between the target value of the width and the measurement result. The 3D printing apparatus 100 controls machining conditions such that the width of the object 4 to be formed approaches the target value, thereby forming the object 4 with high shape accuracy. Here, the target value of the width is the design value of the width of the object 4 in the path of the machining position planned in advance in order to satisfy the size in the width direction of the object 4 that is a final product. The target value of the width is not limited to the design value, and only needs to be a value set for performing highly accurate 3D printing.

Next, a method of measuring the width of the object 4 will be described. The width of the object 4 can also be measured by scanning the machining path again separately for measurement after the machining of the object 4 is completed. In this case, however, it is necessary to scan the machining path twice for each layer, which takes time. The 3D printing apparatus 100 according to the first embodiment measures the width of an already-formed portion of the object 4 during the machining of the object 4. That is, the 3D printing apparatus 100 measures the width of the formed object 4 in parallel with the machining of the object 4. The 3D printing apparatus 100 can perform both additive machining and measurement with just one scanning of the machining path in each layer.

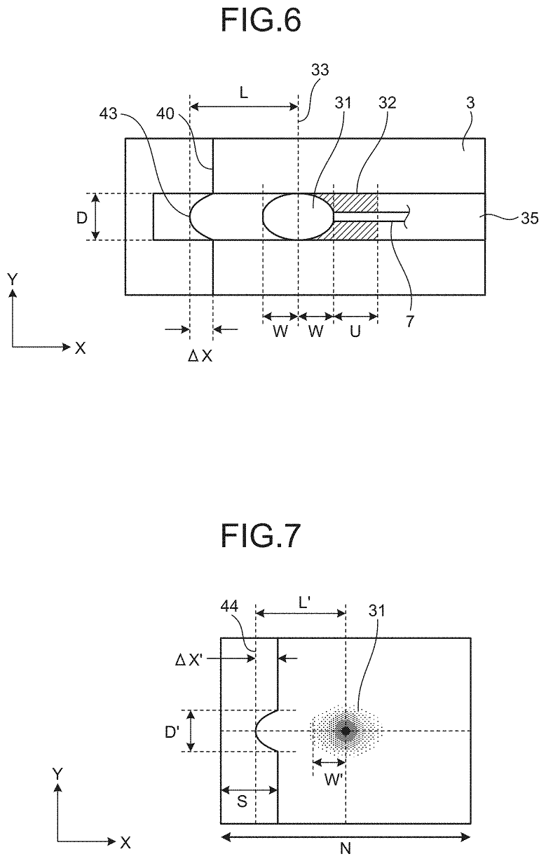

FIG. 5 is a first diagram illustrating machining with the 3D printing apparatus 100 according to the first embodiment. FIG. 6 is a second diagram illustrating machining with the 3D printing apparatus 100 according to the first embodiment. FIG. 5 shows a state in which the object 4 being machined is viewed in plan view from a position in the −Y direction with respect to the object 4. FIG. 6 shows a state in which the object 4 being machined is viewed in plan view from a position in the +Z direction with respect to the object 4. FIGS. 5 and 6 show a state in which a bead 35 is formed such that the bead 35 extends in the −X direction. The machining material 7 is supplied from the +X direction toward the −X direction. The machining position moves in the −X direction with respect to the workpiece 3. In FIG. 5, a measurement position 43 for the width of the object 4 is a position moved in the −X direction from the machining position. Reference character “L” is the distance from the machining position to the measurement position 43.

An area where the machining material 7 is in a molten state on the workpiece 3 by irradiation with the beam 30 is referred to as a melt pool 31. The melt pool 31 is formed at the machining position. As illustrated in FIG. 5, as the drive stage 6 with the workpiece 3 placed thereon moves in the +X direction, the machining position moves in the −X direction on the workpiece 3. Consequently, the bead 35 is formed extending in the −X direction.

At the machining position, the melt pool 31 and its surroundings are hot. While the drive stage 6 is moved in the +X direction, the melt pool 31 is cooled to form a high-temperature portion 32. The high-temperature portion 32 is a high-temperature area adjacent to the melt pool 31 currently machined and in which solidification is insufficient. The high-temperature portion 32 is formed behind the melt pool 31 currently machined, that is, at a position in the +X direction with respect to the melt pool 31. As the high-temperature portion 32 is cooled over time, the metal bead 35 solidified into a certain shape is formed. Here, the ends of the melt pool 31 in the X direction are the positions at a distance W from a center 33 of the machining position, that is, an optical axis CL of the beam 30. Further, the high-temperature portion 32 is the area between the end of the melt pool 31 in the +X direction and the position at a distance U in the +X direction from the end.

Because the machining position moves in the −X direction on the workpiece 3, the high-temperature portion 32 is formed at a position in the +X direction with respect to the machining position. On the other hand, the width of the object 4 is measured at a position in the −X direction with respect to the machining position. That is, the measurement position 43 is a position in the same direction, relative to the machining position, as the direction in which the machining position moves on the workpiece 3. Because the high-temperature portion 32 is not formed in the −X direction with respect to the machining position, the measurement position 43 is set simply by avoiding only the melt pool 31. The measurement position 43 is set at a position in the −X direction with respect to the end of the melt pool 31 in the −X direction. That is, the distance L between the center 33 of the machining position and the measurement position 43 is longer than the distance W. The measurement illumination unit 8 radiates the line beam 40 to this measurement position 43.

In this manner, the measurement position 43 is set in the same direction, relative to the machining position, as the direction in which the machining position moves on the workpiece 3, that is, the running direction in the machining path. This enables the 3D printing apparatus 100 to measure the width of the object 4 near the machining position. The measurement position 43 is a position on the machining path, and can be understood as a machining position at which machining is performed after the current machining position. Since the measurement position 43 also serves as the machining position, the width can be measured at a position closer to the machining position. Therefore, it is desirable that the measurement position 43 be set in the direction in which the machining position moves on the workpiece 3 as viewed from the current machining position. Since the measurement position 43 is set in the direction opposite to the direction in which the high-temperature portion 32 is generated relative to the machining position, the high-temperature portion 32 in which solidification is insufficient does not affect the measurement of the width, and the measurement position 43 can be set close to the machining position.

As illustrated in FIG. 5, the 3D printing apparatus 100 according to the first embodiment radiates the line beam 40 to a position in the same direction as the running direction of the machining path as viewed from the machining position. Unlike in FIG. 5, if the drive stage 6 is moved in the −X direction and the machining material 7 is supplied from the +X direction to the −X direction, setting the measurement position 43 at a position in the same direction as the running direction of the machining path as viewed from the machining position may result in the machining material supply unit 10 or the machining material 7 interfering with the line beam 40. This situation can be prevented by configuring the machining material supply unit 10 or the machining material 7 so as not to interfere with the line beam 40. Therefore, even when the drive stage 6 is moved in the −X direction and the machining material 7 is supplied from the +X direction to the −X direction, the measurement position 43 may be set at a position in the same direction as the running direction of the machining path as viewed from the machining position.

In the first embodiment, the measurement position 43 may be set at a position in the same direction as the direction in which the high-temperature portion 32 is generated as viewed from the machining position. For example, when the drive stage 6 is moved in the −X direction and the machining material 7 is supplied from the +X direction to the −X direction, the high-temperature portion 32 is generated in the −X direction as viewed from the machining position. In this case, the measurement position 43 may be set at a position in the −X direction as viewed from the machining position. By setting the measurement position 43 at a position on the bead 35 away in the −X direction with respect to the high-temperature portion 32 from the machining position, the 3D printing apparatus 100 can measure the width of the object 4.

If the measurement position 43 is a position on the melt pool 31 or on the high-temperature portion 32, because the shape of the molten portion, namely the melt pool 31 or the high-temperature portion 32, is unstable, the measurement accuracy of the width of the object 4 decreases. In addition, because the melt pool 31 has such a high temperature that the metal melts, high-intensity thermal radiation light that hinders measurement is generated from the melt pool 31. It is desirable that the measurement position 43 be not a position on the melt pool 31, that is, be a position away from the center 33 of the machining position by the distance W or more. In addition, insufficient reflection of the line beam 40 by the liquid metal in the molten portion can make it difficult to detect the line beam 40 in the light receiver 16. The state of melting differs between different positions in the molten portion, which may result in a measurement error that depends on the state of melting at the measurement position 43. Further, there is an error due to thermal shrinkage of metal between the width of the molten portion and the width of the bead 35 solidified.

Therefore, it is desirable that the measurement position 43 be a portion other than the molten portion, namely the melt pool 31 or the high-temperature portion 32. By setting the measurement position 43 away from the molten portion, reflected light from the measurement position 43 can be separated from thermal radiation light. Note that as long as sufficient measurement accuracy can be obtained with respect to the creation accuracy required for the object 4, the measurement position 43 may be set at a position close to the center 33 of the machining position, such as a position on the melt pool 31 or a position on the high-temperature portion 32.

Next, an operation in which the width of the object 4 is measured from the cross-sectional height distribution measured using a light section method will be described. The calculation unit 50 calculates the cross-sectional height distribution of the object 4 at the machining position. The cross-sectional height distribution is the distribution of heights of the object 4 in a cross section of the object 4 perpendicular to a first direction. The first direction is the direction in which the machining position is moved with respect to the workpiece 3. In the example illustrated in FIGS. 5 and 6, the cross section is a YZ cross section perpendicular to the X direction which is the first direction. The cross-sectional height distribution is the distribution of heights of the object 4 in the YZ cross section of the object 4 passing through the machining position. The height of the object 4 is the height in the Z direction, i.e. a second direction in which the beads 35 are stacked.

The calculation unit 50 computes the width of the object 4 from the measurement result of the cross-sectional height distribution. In the example illustrated in FIGS. 5 and 6, the width of the object 4 is the width in the Y direction, i.e. a third direction perpendicular to the X direction which is the first direction and the Z direction which is the second direction. The calculation unit 50 computes the cross-sectional height distribution based on the detection result of reflected light in the light-receiving element, and computes the width of the object 4 based on the cross-sectional height distribution. That is, the calculation unit 50 computes the width of the object 4 through calculation using the detection result of reflected light in the light-receiving element.

As illustrated in FIG. 5, the height of the object 4 from the upper surface of the workpiece 3 is denoted by ΔZ, and the angle between the upper surface of the workpiece 3 and the line beam 40 is denoted by θ. Reference character “ΔX” represents the interval between the irradiation position of the line beam 40 on the upper surface of the workpiece 3 and the irradiation position of the line beam 40 on the object 4, which is expressed as ΔX=ΔZ/tan θ. In the XY plane illustrated in FIG. 6, there is a gap of ΔX in the irradiation position of the line beam 40 between the object 4 and the upper surface of the workpiece 3.

FIG. 7 is a diagram illustrating an example of an image of the line beam 40 formed on the light-receiving element in the first embodiment. The difference between the height of the object 4 and the height of the workpiece 3 causes a gap of ΔX′ in the irradiation position of the line beam 40 in the formed image between the object 4 and the workpiece 3. Given that the magnification of the light-receiving optical system is M, ΔX′ is expressed as ΔX′=M×ΔX. Assuming that the size of one pixel of the image sensor which is the light-receiving element is P, a height displacement amount ΔZ′ per pixel is expressed as ΔZ′=P×tan θ/M. For example, given P=5.5 μm, M=1/2, and θ=72 deg, ΔZ′=33.8 μm is obtained. Thus, the calculation unit 50 can compute the cross-sectional height distribution of the object 4 based on the principle of triangulation from the position of the line beam 40 in the image captured by the image sensor. Reference character “L′” is the distance from the machining position to the measurement position 43 in the image of the workpiece 3.

Here, the X-directional position on the image sensor corresponding to the height that is the focal position of the machining laser 1, the measurement illumination unit 8, and the light-receiving optical system is set as a reference pixel position 44. By calculating the difference from the reference pixel position 44, the difference from the height supposed to be created can be calculated. In addition, if it is possible to measure the upper surface of the workpiece 3, the height of the object 4 can also be computed from the difference in the irradiation position of the line beam 40 between the upper surface of the workpiece 3 and the upper surface of the object 4. The height of the object 4 from the upper surface of the workpiece 3 can become so high that the reflected light of the line beam 40 from the upper surface of the workpiece 3 cannot be received, in which case the height of the object 4 can be computed using the amount of raising of the drive stage 6 and the position of the reflected light from the upper surface of the object 4 in the visual field on the light-receiving element.

Here, let H represent the range of measurement height relative to the focal height of the light-receiving optical system. The movement amount S of the line beam 40 with respect to the height range H is expressed as S=H×M/tan θ. It is desirable to design N, which is the number of pixels of the light-receiving element in the X direction, such that the light-receiving optical system can secure at least the visual field in the range of W′+S, which is the sum of the distance W′ from the image center to the end of the melt pool 31 and the movement amount S.

The calculation unit 50 computes the width of the object 4 from the cross-sectional height distribution of the object 4 measured in this manner. Given that the bead width is D as illustrated in FIG. 6, the bead width D′ on the light-receiving element is D′=M×D as illustrated in FIG. 7.

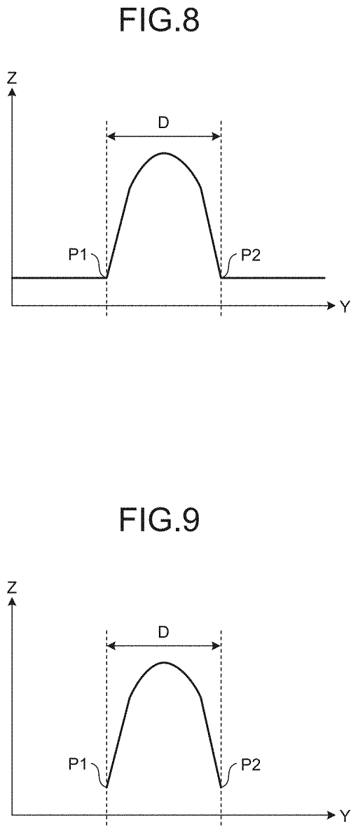

FIG. 8 is a diagram for explaining a first example of computing the width of the object 4 from the measurement result of the cross-sectional height distribution of the object 4 in the first embodiment. FIG. 8 illustrates an example of the cross-sectional height distribution on the light-receiving element in the case that the number of created layers is small and the upper surface of the workpiece 3 can be measured. In FIG. 8, the horizontal axis represents the position in the Y direction on the object side, and the vertical axis represents the height in the Z direction.

In the first example, the bead width D can be computed as the distance between boundary points P1 and P2 between the bead and the flat portion on the workpiece 3. For example, the boundary points P1 and P2 can be computed as points at which the difference in height between measurement points adjacent to each other in the Y direction first becomes equal to or less than a certain threshold. Specifically, the difference in height between measurement points adjacent to each other is obtained sequentially by moving the measurement point in the −Y direction from the center of the bead in the Y direction, and the first point at which the difference becomes equal to or less than the threshold is identified as the boundary point P1. In addition, the difference in height between measurement points adjacent to each other is obtained sequentially by moving the measurement point in the +Y direction from the center of the bead in the Y direction, and the first point at which the difference becomes equal to or less than the threshold is identified as the boundary point P2. Another possible method of computing the boundary points P1 and P2 is to compute a Y-directional position at which the amplitude represented by the height of the bead vertex from the flat portion on the workpiece 3 is equal to or less than a threshold.

FIG. 9 is a diagram for explaining a second example of computing the width of the object 4 from the measurement result of the cross-sectional height distribution of the object 4 in the first embodiment. FIG. 9 illustrates an example of the cross-sectional height distribution on the light-receiving element in the case that the upper surface of the workpiece 3 cannot be measured due to the increased height of the object 4 after continuous 3D printing. In FIG. 9, the horizontal axis represents the position in the Y direction on the object side, and the vertical axis represents the height in the Z direction.

In the second example, reflected light from the flat portion on the workpiece 3 cannot be obtained, and thus the measured cross-sectional height distribution is only the height distribution of the bead upper portion from which reflected light is obtained. The bead width D can be computed as the distance between the boundary points P1 and P2 which are measurement points at which reflected light starts to be obtained. Possible methods of computing the boundary points P1 and P2 are to search for a point whose height is measured from the Y-directional position of the bead vertex or the image end, to obtain a Y-directional position whose height is equal to or less than a certain threshold with respect to the height of the bead vertex, and the like. In this manner, the calculation unit 50 can measure the width of the object 4 from the cross-sectional height distribution measured by the height measurement unit. Note that the above-described methods of computing the width of the object 4 are only examples, and an optimum computation method can be selected by considering, for example, that reflected light from some measurement points on the bead may not be detected by the light-receiving element.

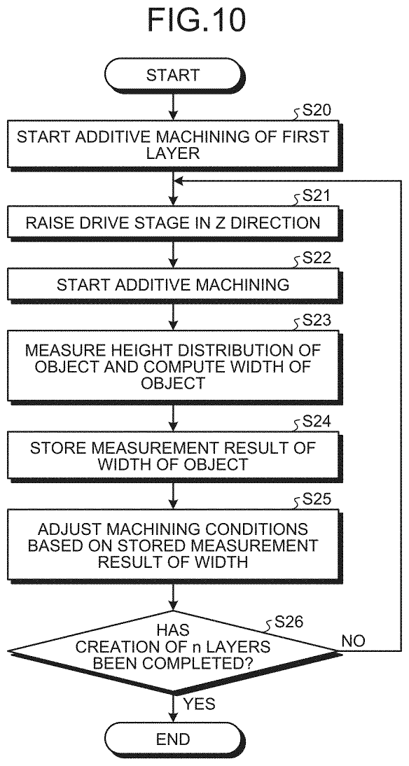

Next, a procedure for controlling machining conditions based on the measurement result of the width of the object 4 will be described. FIG. 10 is a flowchart illustrating a procedure for controlling the bead width through machining condition control in the first embodiment.

First, in step S20, the 3D printing apparatus 100 starts the additive machining of the first layer. The first layer is the layer created first on the workpiece 3. There is no bead at the measurement position 43 at the time of the additive machining of the first layer; therefore, the 3D printing apparatus 100 does not measure the width. That is, at the time of the additive machining of the first layer, the 3D printing apparatus 100 skips the step of measuring the width of the object 4. However, if the surface to be machined is not a flat surface of the workpiece 3 but a surface of the object 4 that has already been created, the 3D printing apparatus 100 may measure the width of the object 4.

Once the creation of the first layer is completed, the 3D printing apparatus 100 raises the drive stage 6 in the Z direction in step S21. In step S22, the 3D printing apparatus 100 starts the additive machining of the second layer, which is the next layer. In step S23, the 3D printing apparatus 100 measures the height distribution of the object 4 by irradiation with the line beam 40 along with the additive machining, and computes the width of the object 4. The 3D printing apparatus 100 computes the bead width of the first layer at the time of the additive machining of the second layer. In step S24, the 3D printing apparatus 100 stores the measurement result of the width of the object 4.

In step S25, the 3D printing apparatus 100 adjusts machining conditions based on the stored measurement result of the width. The 3D printing apparatus 100 performs additive machining while controlling machining conditions by adjusting machining conditions. Consequently, the 3D printing apparatus 100 performs machining control using the stored measurement result at the time of the next additive machining at each measurement position 43 from which the measurement result has been obtained.

The interval between adjacent measurement positions 43 at which the width of the object 4 is measured through the computation in step S23 is determined based on the frame rate of the image sensor which is the light-receiving element and the scanning speed of the machining position. For example, given that the frame rate is F [fps] and the moving speed of the drive stage 6 is v [mm/s], the interval Λ [mm] between adjacent measurement positions 43 in the direction in which the machining position moves with respect to the workpiece 3 is expressed as Λ=v/F. Given that the distance from the machining position to the measurement position 43 is L, the measurement result obtained L/Λ measurement cycles before corresponds to the current machining position. In practice, the position of the drive stage 6 and the measurement position 43 are associated with each other for each machining position; therefore, the 3D printing apparatus 100 can refer to the measurement result corresponding to the current machining position based on the position of the drive stage 6. More specifically, when machining the i-th layer, the 3D printing apparatus 100 measures at the measurement position 43 the width of the object 4 to the (i−1)-th layer, and L/Λ measurement cycles after this measurement time point, performs machining control using the measurement result obtained at the measurement position 43. In this manner, the control unit 51 controls the machining conditions for the layer to be newly created at the measurement position 43 according to the measurement result. Here, i is an integer satisfying 2≤i≤n.

In step S26, the 3D printing apparatus 100 determines whether the creation of the n layers has been completed. In response to determining that the creation of the n layers has not been completed (step S26: No), the 3D printing apparatus 100 returns the procedure to step S21 to raise the drive stage 6 in the Z direction and start creating the next layer. The 3D printing apparatus 100 repeats the procedure of steps S21 to S26 until the creation of the n layers is completed.

On the other hand, in response to determining that the creation of the n layers has been completed (step S26: Yes), the 3D printing apparatus 100 ends the formation of the object 4 with the procedure illustrated in FIG. 10. The 3D printing apparatus 100 forms the object 4 that is a final product having a desired shape by creating all the n layers.

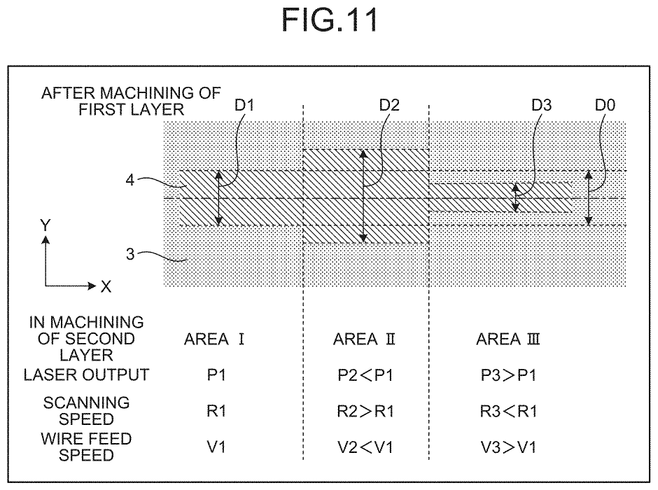

FIG. 11 is a diagram for explaining machining control that is based on the measurement result of the width of the object 4 in the first embodiment. FIG. 11 shows a state after the creation of the object 4 which is the first layer on the workpiece 3. Areas I, II, and III each represent an area in the XY plane of the first layer. D1 represents the bead width in area I. D2 represents the bead width in area II. D3 represents the bead width in area III. D0 represents the target bead width, that is, the design value. It is assumed that D0, D1, D2, and D3 satisfy D0=D1, D2>D0, and D3<D0.

The control unit 51 controls machining conditions for changing the amount of deposition in the second layer based on the measurement result of the first layer. The control unit 51 controls machining conditions by changing parameters such as the laser output of the machining laser 1, the scanning speed that is the moving speed of the drive stage 6, and the wire feed speed that is the supply speed of the machining material 7, for example. The first embodiment describes the case of changing the laser output. Suppose that the laser output, the moving speed of the drive stage 6, and the supply speed of the machining material 7 for making the bead width the target D0 are P1, R1, and V1, respectively. When area I in the second layer is machined, because D1 which is the measurement result of the first layer is the same as D0, the control unit 51 does not change machining conditions. That is, the control unit 51 does not change the laser output from P1.

The control unit 51 reduces the output of the beam 30 when the width of the object 4 measured is greater than a preset target value, and increases the output of the beam 30 when the width of the object 4 measured is smaller than the preset target value. For example, when area II in the second layer is machined, because D2 which is the measurement result of the first layer is larger than D0, the control unit 51 changes the laser output to P2 smaller than P1 so as to reduce the bead width. The reduced laser output makes the bead less likely to melt, which reduces the bead width. When area III in the second layer is machined, because D3 which is the measurement result of the first layer is smaller than D0, the control unit 51 changes the laser output to P3 larger than P1 so as to increase the bead width. The increased laser output makes the bead more likely to melt, which increases the bead width.

In this manner, the control unit 51 controls machining conditions according to the difference between the preset width of the bead to be newly deposited on the object 4 and the measurement result. The relationship between the laser output and the width of the bead to be deposited is computed in advance and held in the 3D printing apparatus 100. Based on this relationship, the control unit 51 obtains a control value for the laser output corresponding to the width of the bead. In addition, in the case of creating a plurality of layers, the control unit 51 may dynamically change the control value during the additive machining using the measurement result of the bead width deposited based on the measurement result for the layer immediately before the layer currently subjected to the additive machining. As described above, it is possible that in the course of the creation along one machining trajectory, the bead width can partially deviate from the design value. The 3D printing apparatus 100 cannot correct the already-created bead width, but if the bead width is narrow, can perform creation under conditions that would make the next bead thick, so that the melted bead can wrap around the layer immediately below to increase the bead width.

The control unit 51 may perform machining control by changing a parameter other than the laser output, namely the moving speed of the drive stage 6 or the supply speed of the machining material 7. The control unit 51 may increase the speed at which the machining position is moved when the width of the object 4 measured is greater than a preset target value, and reduce the speed at which the machining position is moved when the width of the object 4 measured is smaller than the preset target value. The control unit 51 may reduce the supply speed of the machining material 7 when the width of the object 4 measured is greater than a preset target value, and increase the supply speed of the machining material 7 when the width of the object 4 measured is smaller than the preset target value.

For example, when area II in the second layer is machined, the control unit 51 changes the moving speed to R2 higher than R1 so as to reduce the bead width. Alternatively, the control unit 51 changes the supply speed to V2 lower than V1 so as to reduce the bead width. When area III in the second layer is machined, the control unit 51 changes the moving speed to R3 lower than R1 so as to increase the bead width. Alternatively, the control unit 51 changes the supply speed to V3 higher than V1 so as to increase the bead width.

The control unit 51 may perform machining control by changing not only one parameter but also a plurality of parameters. In addition, in case of a temporary failure in the measurement of the width of the object 4 in a certain measurement cycle, the control unit 51 may hold the measurement result obtained one measurement cycle before the failed measurement cycle, and control the machining conditions based on the held measurement result. In case of a temporary failure in the measurement of the width of the object 4, the control unit 51 may control the machining conditions based on the measurement result for the layer immediately before the failed layer. In case of a temporary failure in the measurement of the width of the object 4, the control unit 51 may set the machining conditions to machining conditions for creating a bead having a bead width of D0.

In addition, in a case where the measurement position 43 is provided in the same direction as the direction in which the high-temperature portion 32 is generated with respect to the machining position, that is, in a case where the measurement position 43 is provided on the rear side with respect to the running direction of additive machining, when the i-th layer is deposited, the height of the i-th layer after deposition is measured. Therefore, in the case of controlling machining conditions using the measured height of the machining material supply unit 10, the control unit 51 stores, for the entire i-th layer, the measurement result for the measurement position 43 in the i-th layer, and uses the measurement result when depositing the (i+1)-th layer.

In this manner, the control unit 51 controls machining conditions to bring the width of the object 4 to be formed close to the target value indicating the width of the designed shape. The 3D printing apparatus 100 according to the first embodiment can bring the width of the object 4 close to the target width by measuring the bead width in the running direction of additive machining during the machining, and optimally controlling machining conditions at the next machining such that the bead width approaches the target value. The 3D printing apparatus 100 cannot correct the width of the already-created bead, but can correct the bead width to be created as the bead width gradually deviates from the design value due to heat storage or the like by measuring the width of the formed object 4 and controlling machining conditions at the time of the next machining.

For example, during continuous creation, the continuous deposition time becomes longer due to the influence of heat storage, and the bead width gradually increases as the number of deposits increases. However, the 3D printing apparatus 100 according to the first embodiment can measure increases in bead width as the creation progresses, and therefore can bring the bead width close to the target width by optimally controlling machining conditions. The 3D printing apparatus 100 may further improve the creation accuracy with a method of predicting the bead width of the next deposit from the change in bead width with respect to the number of deposits, heat storage (object temperature), machining conditions, and the like, and controlling machining conditions such that the bead width approaches the target value.

The 3D printing apparatus 100 according to the first embodiment measures not only the bead width but also the bead height, i.e. the height of the bead in the Z direction. The 3D printing apparatus 100 may optimally control machining conditions such that both the bead width and the bead height approach the design values. In this case, the control unit 51 controls machining conditions to bring the width of the object 4 to be formed close to the target value indicating the width of the designed shape, and to bring the height of the object 4 to be formed close to the target value indicating the height of the designed shape. Consequently, the 3D printing apparatus 100 can perform creation with higher accuracy.

In the machining condition control, the 3D printing apparatus 100 may control both the bead width and the bead height by changing one parameter, but may control both the bead width and the bead height by changing a plurality of control parameters. For example, the bead width is desirably controlled by changing the laser output, and the bead height is desirably controlled by changing the supply speed of the machining material 7.

The 3D printing apparatus 100 may control the height of the object 4 by changing the amount of raising of the drive stage 6. In this case, the control unit 51 increases the amount by which the workpiece 3 is raised in the +Z direction when the height of the object 4 measured is greater than a preset target value, and reduces the amount by which the workpiece 3 is raised in the +Z direction when the height of the object 4 measured is smaller than the preset target value. The 3D printing apparatus 100 can optimally change the amount of raising of the drive stage 6 after the creation of each layer according to the measurement result of the bead height, thereby dynamically changing the amount of raising during creation.

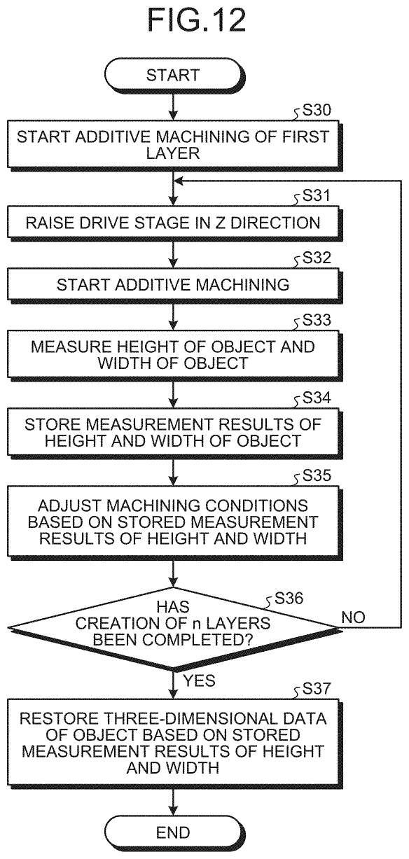

The calculation unit 50 may store the data of bead width and bead height measured for each layer of the object 4, and restore the three-dimensional shape of the object 4 using the stored data after the creation of all the layers is completed. FIG. 12 is a flowchart illustrating a procedure for restoring a three-dimensional shape based on the measurement results of bead width and bead height in the first embodiment.

First, in step S30, the 3D printing apparatus 100 starts the additive machining of the first layer. Once the creation of the first layer is completed, the 3D printing apparatus 100 raises the drive stage 6 in the Z direction in step S31. In step S32, the 3D printing apparatus 100 starts the additive machining of the second layer, which is the next layer. In step S33, the 3D printing apparatus 100 measures the height of the object 4 and the width of the object 4 by irradiation with the line beam 40. In step S34, the 3D printing apparatus 100 stores the measurement results of the height and width of the object 4.

In step S35, the 3D printing apparatus 100 adjusts machining conditions based on the stored measurement results of height and width. The 3D printing apparatus 100 performs additive machining while controlling machining conditions by adjusting machining conditions based on both the measurement result of height and the measurement result of width. The 3D printing apparatus 100 may control machining conditions based on only one of the measurement result of height and the measurement result of width.

In step S36, the 3D printing apparatus 100 determines whether the creation of the n layers has been completed. In response to determining that the creation of the n layers has not been completed (step S36: No), the 3D printing apparatus 100 returns the procedure to step S31 to raise the drive stage 6 in the Z direction and start creating the next layer. The 3D printing apparatus 100 repeats the procedure of steps S31 to S36 until the creation of the n layers is completed.

On the other hand, in response to determining that the creation of the n layers has been completed (step S36: Yes), the 3D printing apparatus 100 restores the three-dimensional data of the object 4 based on the stored measurement results of height and width in step S37. The 3D printing apparatus 100 ends the operation with the procedure illustrated in FIG. 12. The three-dimensional data is used for evaluating the gap between the shape of the object 4 that is a final product and the designed shape. Based on the evaluation result, a portion of the object 4 having insufficient material can be subjected to additional creation, and a portion of the object 4 having excessive material can be removed through cutting or the like.

Creation that is performed continuously in a short time in the same path causes heat storage in the object 4. Therefore, it is possible that the width or height of the object 4 measured during the creation can be different from the width or height of the object 4 cooled after the completion of the creation. In this case, the excess or deficiency of the object 4 is computed by considering the thermal strain after the completion of the creation so that additional machining can be performed. In addition, the amount of thermal strain after the completion of the creation of the object 4 can be computed by comparing the three-dimensional shape obtained based on the measurement results during the creation with the three-dimensional shape measured after the completion of the creation.

The 3D printing apparatus 100 according to the first embodiment can accurately measure the width of the object 4 by measuring the width of an already-created portion of the object 4. In addition, the 3D printing apparatus 100 can secure measurement results less susceptible to the machining material 7, machining conditions, and the like.

In the 3D printing apparatus 100, because the objective lens 13 is shared by the light-receiving optical system and the machining optical system, the light-receiving optical system is integrated with the machining head 2 so that the apparatus configuration can be downsized. In addition, because the light-receiving element can acquire an image of the line beam 40 at a position as close as possible to the machining position, the 3D printing apparatus 100 can measure the width of the object 4 as close as possible to the machining position. Because the 3D printing apparatus 100 can measure the width of the object 4 near the machining position, the range in which the width or height of the object 4 cannot be measured can be reduced to the minimum extent possible even when the machining path is complicated.

For example, in a case where the direction in which the machining position moves rapidly changes, the farther the measurement position 43 is from the machining position ahead of the measurement position 43, the larger the range in which the width or height of the object 4 cannot be measured after the change of the direction in which the machining position moves. On the other hand, in the apparatus configuration according to the first embodiment, in which the objective lens 13 is shared by the light-receiving optical system and the machining optical system and the light-receiving optical system is integrated with the machining head 2, the range in which the width cannot be measured is small when creating the object 4 which is complicated and requires frequent changes in the direction in which the machining position moves, and the creation accuracy can be improved. As described above, according to the first embodiment, the 3D printing apparatus 100 can measure the width of the object 4 with high accuracy at a position as close as possible to the machining position regardless of the machining material 7 or the shape of the object 4. The 3D printing apparatus 100 can form the object 4 with the bead width as designed during continuous creation by controlling machining conditions using the measurement result. Thus, the 3D printing apparatus 100 can achieve the unprecedented, remarkable effect that the object 4 with high shape accuracy can be formed and the creation accuracy of complicated shapes can be improved.

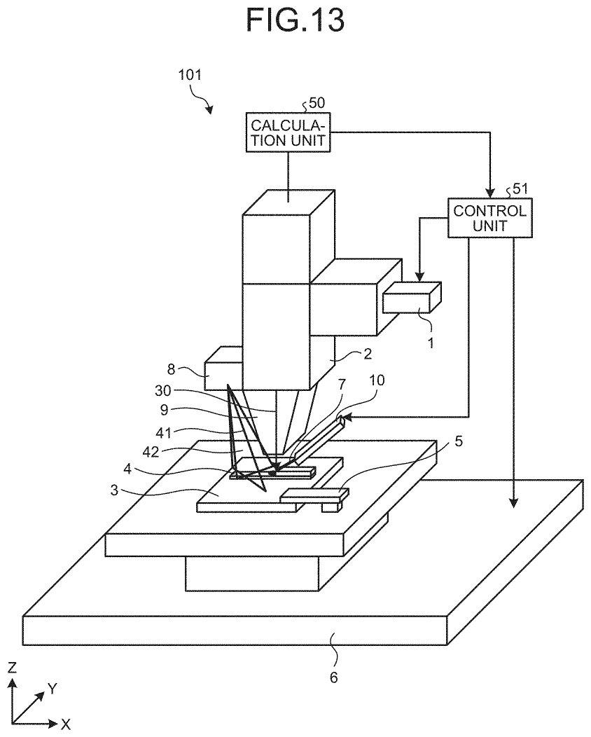

Next, a modification of the first embodiment will be described. FIG. 13 is a perspective diagram illustrating a configuration of a 3D printing apparatus 101 according to a modification of the first embodiment. The 3D printing apparatus 101 measures the width of the object 4 by radiating two line beams 41 and 42 as illumination light from the measurement illumination unit 8.

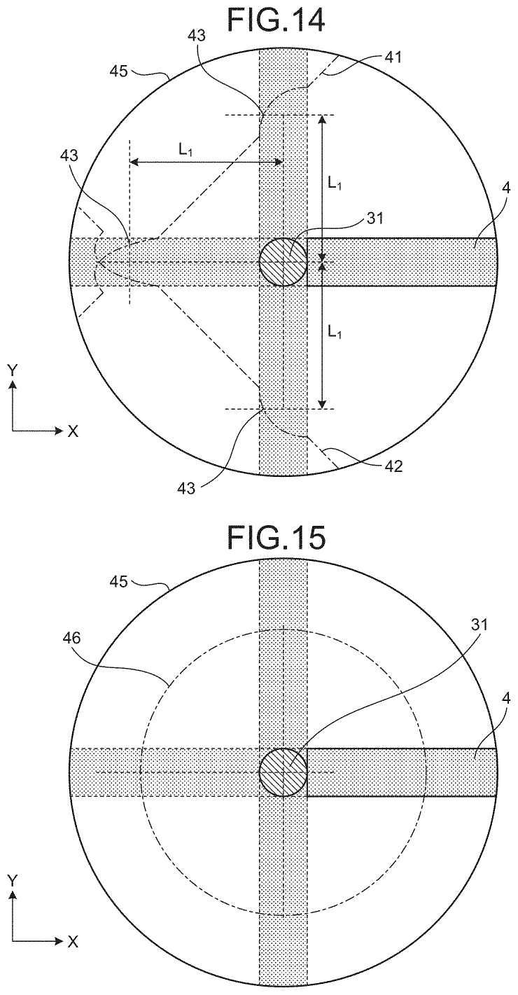

FIG. 14 is a diagram illustrating the line beams 41 and 42 for use in measuring the width of the object 4 in the modification of the first embodiment. FIG. 14 depicts the line beams 41 and 42 and the object 4 in a visual field 45 of the light-receiving element. The measurement illumination unit 8 is located, for example, at a position in the −X direction with respect to the machining head 2. The measurement illumination unit 8 radiates the line beams 41 and 42 uninterruptedly extended in the range of ±90 degrees around the −X direction on the side opposite to the +X direction in which the machining material supply unit 10 is located as viewed from the machining position. The distance L₁ illustrated in FIG. 14 is the distance from the machining position to the measurement position 43.

In this manner, by radiating the line beams 41 and 42 in the direction inclined with respect to the optical axis CL of the beam 30, the 3D printing apparatus 101 can measure the cross-sectional height distribution of the object 4 and compute the width of the object 4 even when the machining direction changes in the angular range of ±90 degrees in the direction counter to the direction in which the machining material 7 is supplied.

The line beams 41 and 42 only need to be extended in the range of 90 degrees or more around the −X direction. In the modification of the first embodiment, the measurement illumination unit 8 supplies the illumination light extended in the range of 90 degrees or more on the side opposite to the machining material supply unit 10, which is the supply source of the machining material 7, as viewed from the machining position. That is, the line beams 41 and 42 are uninterruptedly radiated in the angular range of at least ±90 degrees around the optical axis of the light-receiving optical system and relative to the direction counter to the direction in which the machining material 7 is supplied. Consequently, the 3D printing apparatus 101 can measure the cross-sectional height distribution of the object 4 and compute the width of the object 4 even when the machining direction changes in the angular range of 90 degrees or more in the direction counter to the direction in which the machining material 7 is supplied.

However, if the machining direction, which is the direction in which beads are formed, is not orthogonal to the longitudinal direction of the line beams 41 and 42, the width of the object 4 cannot be accurately measured. Therefore, in the modification of the first embodiment, the calculation unit 50 estimates the width of the object 4 in the direction perpendicular to the machining direction using the inclination of the line beams 41 and 42 in the longitudinal direction with respect to the X direction or the Y direction in the XY plane and information on the machining direction. Such estimation allows the 3D printing apparatus 101 to measure the width of the object 4 with high accuracy. In addition, the calculation unit 50 may store the positions in the XY plane of the boundary points P1 and P2, which are the positions of the ends of the object 4 obtained based on the measurement result of the cross-sectional height distribution, and compute the width of the object 4 using the boundary points P1 and P2 included in the cross section perpendicular to the object 4. This also allows the 3D printing apparatus 101 to measure the width of the object 4 with high accuracy.

In this manner, the 3D printing apparatus 101 can measure the width of the object 4 even when creating a complicated three-dimensional shape by changing the machining direction, which allows for creation with high accuracy. Because the line beams 41 and 42 are radiated in the angular range of ±90 degrees from the direction counter to the +X direction in which the machining material 7 is supplied, the calculation unit 50 only has to calculate the position of the center of gravity toward the direction in which the machining material 7 is supplied. Therefore, height calculation processing with the calculation unit 50 can be simplified. Because the 3D printing apparatus 101 can radiate the line beams 41 and 42 from the single measurement illumination unit 8, the apparatus configuration can be downsized as compared with the case of radiating a plurality of line beams for different machining directions using a plurality of measurement illumination units 8.

In the first embodiment, the measurement illumination unit 8 is fixed to the surface of the machining head 2 on the −X direction side, but the measurement illumination unit 8 may be installed at a different position. In addition, a drive mechanism rotatable around the machining head 2 may be provided, and the measurement illumination unit 8 may be rotated according to the machining direction such that the longitudinal direction of the line beam always crosses the object 4. Consequently, the 3D printing apparatuses 100 and 101 can change the longitudinal direction of the line beam such that the longitudinal direction of the line beam always crosses the object 4 as the machining direction changes, and therefore can measure the cross-sectional height distribution of the object 4 and compute the width of the object 4.

In the first embodiment, the line beam radiated from the measurement illumination unit 8 need not necessarily have a linear shape. The line beam may have a non-linear shape. FIG. 15 is a diagram illustrating a modification of a line beam in the first embodiment. The line beam 46 according to the modification is a line beam radiated in a circular shape centered on the optical axis CL.

The line beam 46 is radiated to the object 4 at an irradiation angle θ from all directions in the XY plane. In this case, without the above-described drive mechanism, the 3D printing apparatuses 100 and 101 can cause the line beam 46 to cross the bead perpendicularly regardless of which direction the machining direction is in the XY plane, and thus can measure the cross-sectional height distribution of the object 4 and compute the width of the object 4. The line beam 46 need not necessarily have a strictly circular shape, and may have an arc shape or an elliptical shape. Thus, an arc-shaped line beam shaped like a part of a circle or an elliptical line beam shaped like a deformed circle is also an example of the circular line beam 46.

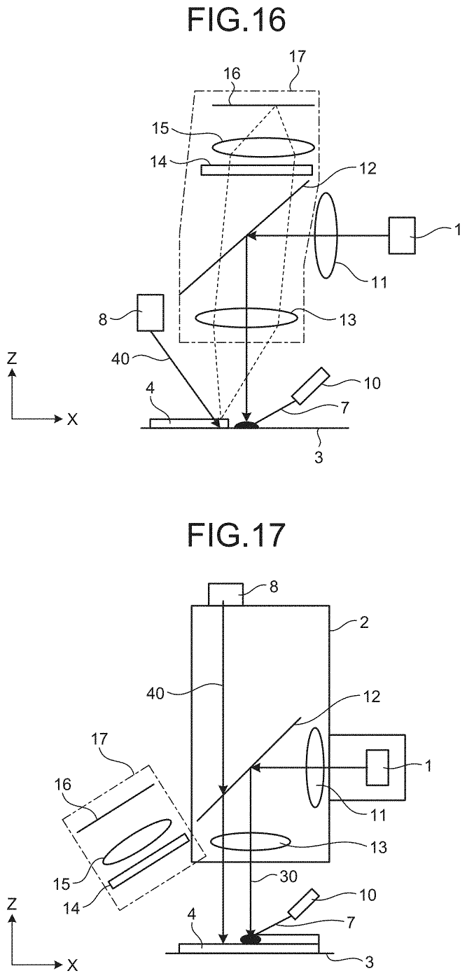

FIG. 16 is a diagram illustrating a first modification of the optical systems of the 3D printing apparatus 100 according to the first embodiment. In the first modification, the central axis of the objective lens 13 is displaced from the central axis of the condenser lens 15. For example, the central axis of the objective lens 13 is displaced in the −X direction from the central axis of the condenser lens 15 as illustrated in FIG. 16. The objective lens 13 is a lens that concentrates the beam 30 on the machining position. In the first modification, the position of the central axis of the optical system that forms an image of the reflected light through the objective lens 13 on the light receiver 16 is different from the position of the central axis of the objective lens 13 that concentrates the beam 30 on the machining position.

This configuration allows the reflected light of the line beam 40 to form an image on the light-receiving element without being significantly affected by the aberration of the lenses, so that the 3D printing apparatus 100 can improve the height measurement accuracy. The above-described configuration in which the position of the central axis is displaced may be replaced with a configuration in which the central axis of the light-receiving optical system that forms an image of the reflected light through the objective lens 13 on the light receiver 16 is inclined with respect to the central axis of the objective lens 13, which can also produce a similar effect. In addition, the shape of the lens surface of the condenser lens 15 may be changed. The visual field of the light receiver 16 only needs to be wider than the range in which the line beam 40 moves within the height measurement range. In this case, because the resolution of the line beam 40 can be increased by using the light-receiving optical system that enlarges only the movement range of the line beam 40, the 3D printing apparatus 100 can improve the height measurement accuracy.

In the configuration of the first embodiment, the line beam 40 illustrated in FIG. 5 is radiated at an inclination of θ, and the optical axis of the light-receiving optical system is parallel to the Z direction, which is the vertical direction. Therefore, as the height of the measurement position 43 changes, the measurement position 43 is shifted in the XY direction, which is the horizontal direction. Because the direction in which the measurement position 43 is shifted is computable from the position of the line beam 40 on the light-receiving element, correction is possible but is complicated in terms of calculation. In the second modification below, a configuration that does not cause such measurement position displacement will be described.

FIG. 17 is a diagram illustrating the second modification of the optical systems of the 3D printing apparatus 100 according to the first embodiment. In the second modification, the machining head 2 includes the light-projecting lens 11, the beam splitter 12, the objective lens 13, and the measurement illumination unit 8. The measurement illumination unit 8 is located above the machining head 2. The light-receiving unit 17 including the bandpass filter 14, the condenser lens 15, and the light receiver 16 is located outside the machining head 2. In the second modification, the objective lens 13 constituting the machining optical system also serves as the objective lens that radiates illumination light from the measurement illumination unit 8 to the object 4. In the 3D printing apparatus 100, the objective lens 13 is shared by the machining optical system and the illumination optical system that radiates illumination light to the object 4. Consequently, in the 3D printing apparatus 100, the illumination optical system is integrated with the machining head 2 so that the apparatus configuration can be downsized. The objective lens 13 constitutes the illumination optical system.

The line beam 40 emitted from the measurement illumination unit 8 passes through the beam splitter 12 and passes through the objective lens 13 to be radiated to the measurement position 43 on the object 4. Because the line beam 40 passes through the objective lens 13 for machining, the measurement illumination unit 8 emits the line beam 40 characterized by being concentrated on the object 4 by the objective lens 13. It is necessary to optimally design the optical axis of the line beam 40 that enters the objective lens 13 by using an optical component such as a lens, which is not discussed herein.

As described in the first embodiment, the light-receiving unit 17 includes the bandpass filter 14 that selectively transmits the irradiation wavelength of the line beam 40. The measurement illumination unit 8 projects the line beam 40 in parallel with the optical axis of the beam 30, and the light-receiving unit 17 receives the reflected light reflected in an oblique direction, so that the 3D printing apparatus 100 can measure the cross-sectional height distribution of the object 4 without being affected by the measurement position displacement due to the height of the object 4. Because the optical axis of the light-receiving unit 17 is inclined with respect to the optical axis of the line beam 40, the line beam 40 is projected on the light-receiving element with a displacement that depends on the height of the object 4. Therefore, the calculation unit 50 can compute the cross-sectional height distribution from this position displacement to calculate the bead width. Consequently, even when measuring a complicated three-dimensional shape, the 3D printing apparatus 100 can measure the height of the object 4 always at a constant distance with respect to the machining position with no displacement of the bead width measurement position, and thus can control machining conditions with high accuracy and improve the creation accuracy.

### Second Embodiment

In the second embodiment, the operation for forming the object 4 is different from that in the first embodiment. In the second embodiment, beads are formed not in a linear shape but in a ball shape. In the second embodiment, a formed bead is referred to as a ball bead. In the second embodiment, components identical to those in the first embodiment are denoted by the same reference signs, and configuration differences from the first embodiment will be mainly described.

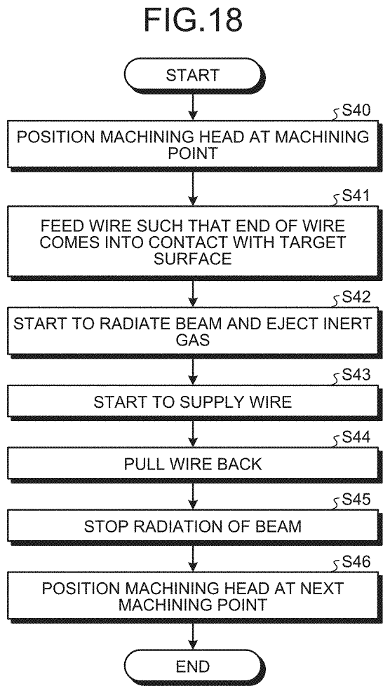

FIG. 18 is a flowchart illustrating an operation procedure for forming a ball bead with the 3D printing apparatus 100 according to the second embodiment. First, in step S40, the 3D printing apparatus 100 drives the drive stage 6 to position the machining head 2 at a first machining position, or a machining point. The surface to be machined is the surface of the workpiece 3 on which a ball bead is formed, specifically the upper surface of the workpiece 3. If a ball bead is formed on the already-created object 4, the surface to be machined is the surface of the object 4.

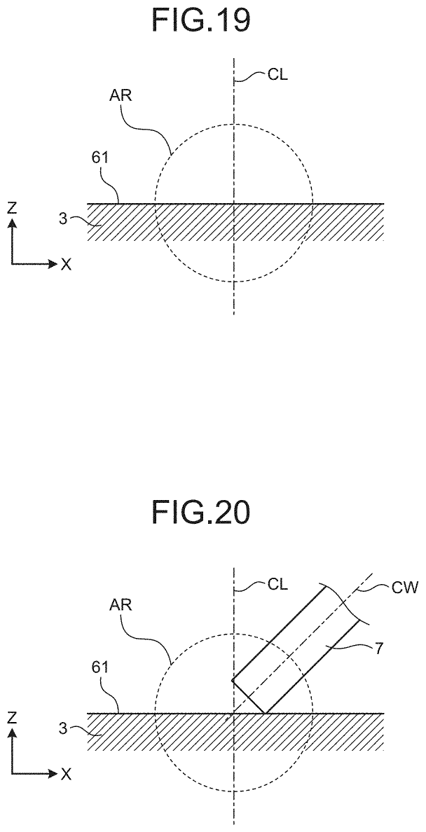

FIG. 19 is a schematic cross-sectional diagram illustrating a machining area AR of the 3D printing apparatus 100 according to the second embodiment. As illustrated in FIG. 19, the machining point is a point at which the optical axis CL of the beam 30 intersects a target surface 61. The target surface 61 is the surface to be machined. In the second embodiment, the machining point is the center position of the machining area AR on the target surface 61.

Returning to FIG. 18, in step S41, the 3D printing apparatus 100 feeds wire as the machining material 7 such that the end of the wire comes into contact with the target surface 61. FIG. 20 is a schematic cross-sectional diagram in which the wire fed to the machining area AR of the 3D printing apparatus 100 according to the second embodiment is in contact with the surface to be machined.

As illustrated in FIG. 20, the 3D printing apparatus 100 feeds the machining material 7, which is wire, obliquely from above the machining area AR to bring the end of the machining material 7 into contact with the target surface 61. Feeding wire means that the 3D printing apparatus 100 controls the machining material supply unit 10 to cause the wire to be discharged from the wire nozzle of the machining material supply unit 10 and supplied to the machining point. Before irradiation with the beam 30, the machining material 7 is in contact with the target surface 61. Therefore, molten wire is stably welded to the target surface 61, which makes it possible to prevent molten wire from not being welded to the target surface 61 and from being welded at a position displaced from the desired position.

It is preferable that the central axis CW of the wire fed from the wire nozzle and brought into contact with the target surface 61 and the optical axis CL of the beam 30 that is radiated onto the machining area AR intersect at the surface of the target surface 61. Alternatively, it is preferable that the central axis CW of the wire intersect the surface of the target surface 61 within the radius of the beam 30 between the wire nozzle and the optical axis CL. Locating the wire in this manner enables the 3D printing apparatus 100 to form on the target surface 61 a ball bead centered on the intersection of the central axis CW of the wire and the optical axis CL.

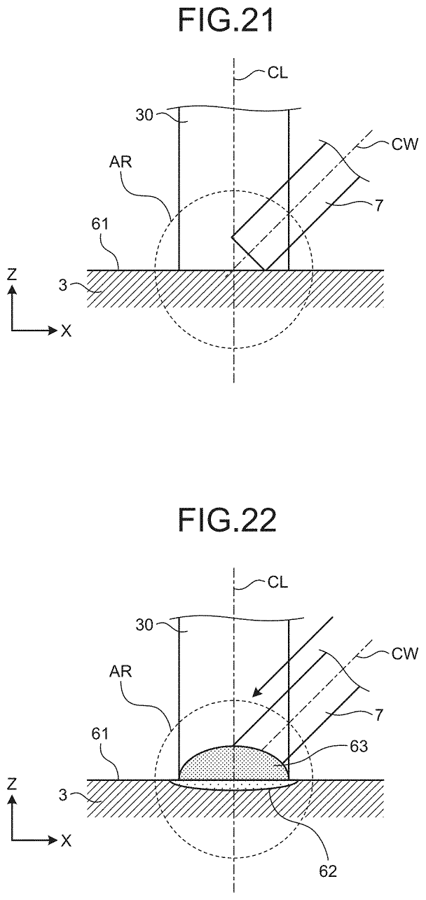

Returning to FIG. 18, once the preparation of the machining material 7 is completed, the 3D printing apparatus 100 starts to radiate the beam 30 and ejects inert gas from the gas nozzle 9 in step S42. FIG. 21 is a schematic cross-sectional diagram in which the beam 30 is radiated to the machining area AR of the 3D printing apparatus 100 according to the second embodiment.

As illustrated in FIG. 21, the 3D printing apparatus 100 radiates the beam 30 toward the machining area AR of the target surface 61. At this time, the beam 30 is radiated to the wire that is the machining material 7 located in the machining area AR. In conjunction with the radiation of the beam 30, the ejection of inert gas from the gas nozzle 9 to the machining area AR is started. It is preferable that the ejection of inert gas be started before the target surface 61 is irradiated with the beam 30. It is also preferable that inert gas be ejected for a predetermined fixed time. Ejecting inert gas for the fixed time before the radiation of the beam 30 enables the 3D printing apparatus 100 to remove active gas such as oxygen remaining in the gas nozzle 9 from the gas nozzle 9.

Returning to FIG. 18, in step S43, the 3D printing apparatus 100 starts to supply the wire that is the machining material 7. FIG. 22 is a schematic cross-sectional diagram in which the supply of wire to the machining area AR of the 3D printing apparatus 100 according to the second embodiment is started.

The 3D printing apparatus 100 controls the wire nozzle of the machining material supply unit 10 to discharge the wire in the direction of the arrow illustrated in FIG. 22, thereby feeding the wire toward the machining area AR of the target surface 61. As a result, the wire located in the machining area AR in advance and the wire supplied to the machining area AR after the start of the radiation of the beam 30 are melted, and the molten material is welded to the target surface 61. In the machining area AR, due to the radiation of the beam 30, the target surface 61 consisting of the surface of the workpiece 3 or the surface of the object 4 is melted to form a melt pool 62. Then, in the machining area AR, the molten material is welded to the melt pool 62. As a result, a molten bead 63 is formed in the machining area AR. The molten bead 63 is an unsolidified bead. After the supply of wire is started, the supply of wire to the machining area AR is continued for a predetermined supply time.

The supply speed of wire can be adjusted by controlling the rotation of the rotary motor of the machining material supply unit 10. The supply speed of wire is limited by the output of the beam 30. That is, there is a correlation between the supply speed of wire and the output of the beam 30 for achieving proper welding of molten material to the machining area AR. The 3D printing apparatus 100 can increase the creation speed of a ball bead by increasing the output of the beam 30.

If the supply speed of wire is too fast with respect to the output of the beam 30, the wire remains unmelted. In contrast, if the supply speed of wire is too slow with respect to the output of the beam 30, the wire is overheated, whereby molten material turns into droplets that fall from the wire, and molten material is not welded into a desired shape.

The size of a ball bead can be adjusted by changing the supply time of wire and the irradiation time of the beam 30. The longer the supply time of wire and the irradiation time of the beam 30, the larger the diameter of the resultant ball bead. On the other hand, the shorter the supply time of wire and the irradiation time of the beam 30, the smaller the diameter of the resultant ball bead.

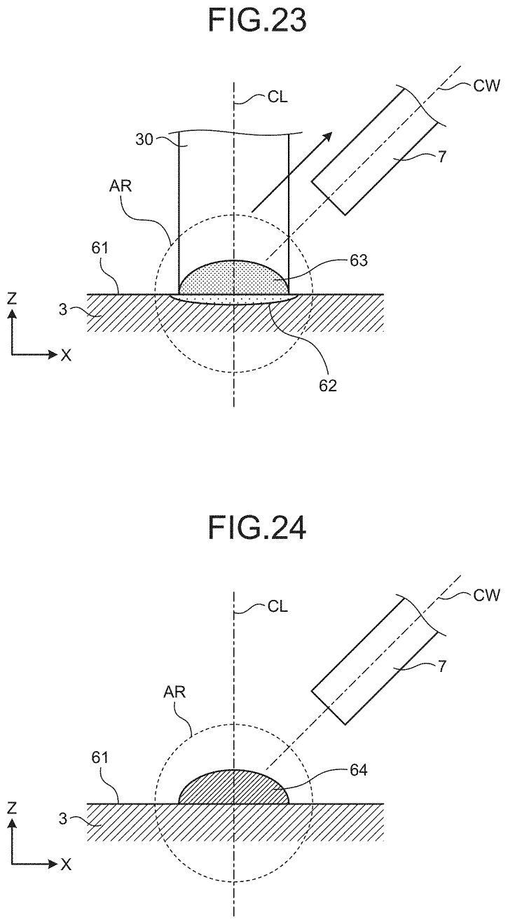

Returning to FIG. 18, once the additive machining at the first machining position is completed, the 3D printing apparatus 100 pulls the wire that is the machining material 7 back from the machining area AR toward the machining material supply unit 10 in step S44. FIG. 23 is a schematic cross-sectional diagram in which the wire is pulled out from the machining area AR of the 3D printing apparatus 100 according to the second embodiment.

Once the additive machining at the first machining position is completed, the 3D printing apparatus 100 pulls out the wire from the machining area AR by pulling the wire back in the direction of the arrow illustrated in FIG. 23. At this time, the melt pool 62 formed in the workpiece 3 and the molten bead 63 are integrated. The melt pool 62 is an area where the workpiece 3 is in a molten state. As the wire is pulled out, the wire is separated from the molten bead 63.

Returning to FIG. 18, after the wire is pulled back, the 3D printing apparatus 100 stops the radiation of the beam 30 in step S45. In addition, the 3D printing apparatus 100 continues ejecting inert gas from the gas nozzle 9 after stopping the radiation of the beam 30. Then, after a lapse of a duration, the 3D printing apparatus 100 stops the ejection of inert gas from the gas nozzle 9.

FIG. 24 is a schematic cross-sectional diagram in which the radiation of the beam 30 to the machining area AR of the 3D printing apparatus 100 according to the second embodiment is stopped. The 3D printing apparatus 100 continues ejecting inert gas for the duration after stopping the radiation of the beam 30. The ejection of inert gas is stopped after the duration elapses, and the molten bead 63 is solidified to form a ball bead 64 on the target surface 61.

The duration is determined based on the time from when the beam 30 is stopped to when the temperature of the molten bead 63 welded to the machining area AR drops to a predetermined temperature. The time to when the temperature of the molten bead 63 drops to a predetermined temperature depends on various conditions such as the material of the wire and the size of the ball bead 64. Duration information based on these conditions is stored in advance in the control unit 51. The temperature of the molten bead 63 drops to a predetermined temperature after a lapse of the duration, and the formation of the ball bead 64 is completed.

Returning to FIG. 18, once the additive machining at the first machining position is completed and the ball bead 64 is formed at the first machining position, the 3D printing apparatus 100 positions the machining head 2 at a second machining position, which is the next machining point, in step S46. Specifically, the 3D printing apparatus 100 controls the drive stage 6 to change the relative position between the workpiece 3 and the machining head 2, thereby positioning the machining head 2 above the second machining position, which is the next machining point.

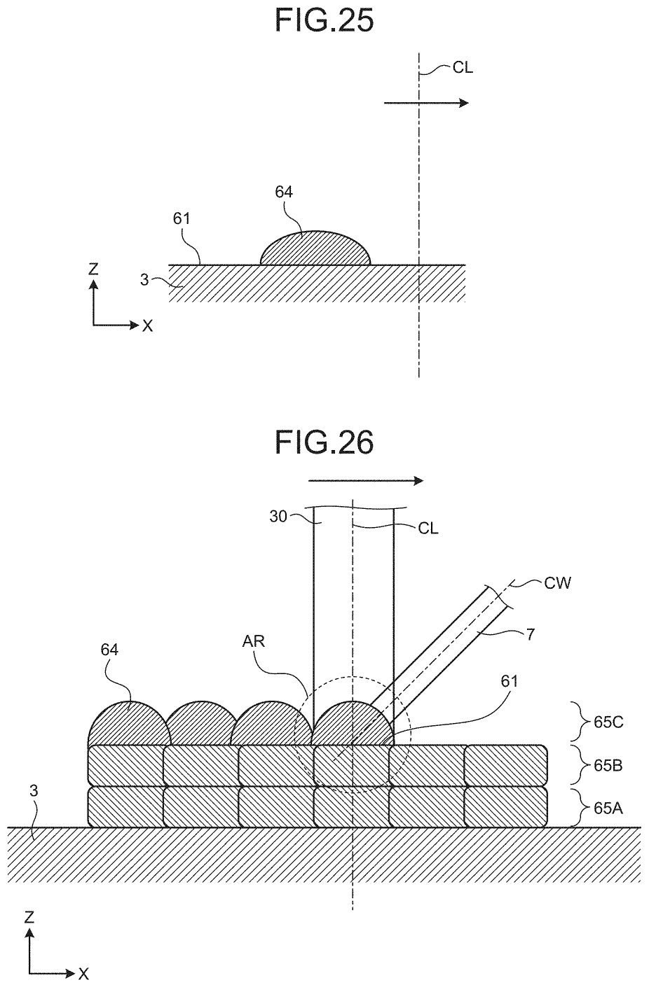

FIG. 25 is a schematic cross-sectional diagram in which the machining head 2 of the 3D printing apparatus 100 according to the second embodiment moves to the next machining point. Note that FIGS. 19 to 25 illustrate the state of a peripheral region of the machining area AR on the target surface 61. In FIGS. 21 to 24, inert gas is not illustrated.

The arrow illustrated in FIG. 25 indicates the moving direction of the machining head 2 with respect to the workpiece 3. Along with the movement of the position of the machining head 2 with respect to the workpiece 3, the optical axis CL of the beam 30 moves in the direction of the arrow with respect to the workpiece 3. The 3D printing apparatus 100 moves the optical axis CL to the second machining position, which is the next machining point.

FIG. 26 is a schematic cross-sectional diagram for explaining a method of creating the object 4 with the 3D printing apparatus 100 according to the second embodiment. By repeating the steps illustrated in FIG. 18, the 3D printing apparatus 100 forms a layer of ball beads 64 constituting the object 4 on the target surface 61. Here, the layer of ball beads 64 directly formed on the surface of the workpiece 3 is referred to as a first layer 65A. In addition, the layer of ball beads 64 formed on the first layer 65A is referred to as a second layer 65B. The layer of ball beads 64 formed on the second layer 65B is referred to as a third layer 65C.

By creating a plurality of layers configured by ball beads 64, the 3D printing apparatus 100 can form the object 4 having a desired shape on the workpiece 3. The 3D printing apparatus 100 changes the position of the drive stage 6 in the Z direction by a certain amount every time the additive machining of each layer is completed. It is preferable that the amount of change in the Z direction be equal to the height of the ball bead 64 to be formed.

The steps illustrated in FIG. 18 need not necessarily be executed in the above order. The second embodiment is not limited to the above-described example, in which when the machining position is moved and the ball bead 64 is created, the step of positioning the machining head 2 above the machining point is separated from the step of discharging wire. In order to shorten the machining time, the 3D printing apparatus 100 may conduct the movement to the next machining point while discharging the wire. This enables the 3D printing apparatus 100 to make the wire already in contact with the target surface 61 by the time the machining head 2 arrives at the next machining point, leading to a reduction in machining time.

The principle of measurement of the width of the object 4 in the second embodiment is similar to that in the first embodiment. The 3D printing apparatus 100 measures the cross-sectional height distribution of the ball bead 64 from the position displacement of the line beam 40 on the light-receiving element based on the principle of triangulation, and computes the width of the ball bead 64. Now, a procedure for measuring the width of the ball bead 64 and performing additive machining control of the ball bead 64 using the measurement result of the bead width will be described.

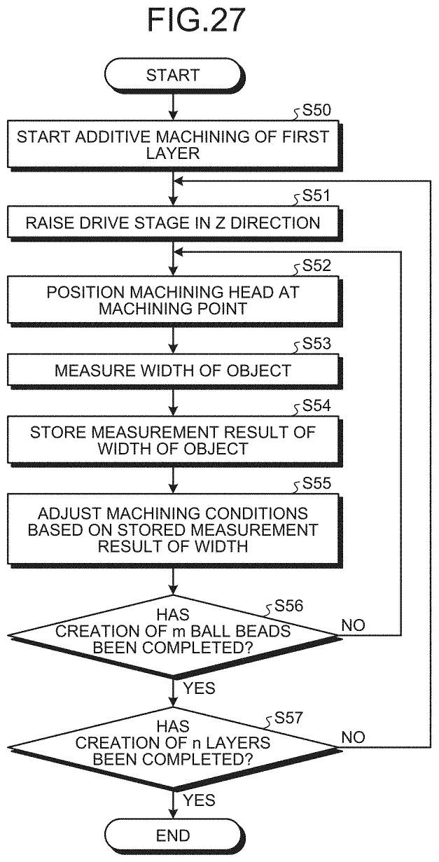

FIG. 27 is a flowchart for explaining a procedure in which the 3D printing apparatus 100 according to the second embodiment performs the additive machining of the ball bead 64 using the measurement result of the width of the already-formed object 4. The following exemplary case is based on the assumption that one layer consists of m ball beads 64 and n layers are deposited to form the object 4. Note that m is a freely-determined integer.

First, in step S50, the 3D printing apparatus 100 starts the additive machining of the first layer 65A. In a case where the workpiece 3 is a base plate having a flat upper surface, there is no bead at the measurement position at the time of the additive machining of the first layer 65A; therefore, the 3D printing apparatus 100 does not measure the width. That is, at the time of the additive machining of the first layer 65A, the 3D printing apparatus 100 skips the step of measuring the width of the object 4. However, if the target surface 61 is not a flat surface of the workpiece 3 but a surface of the object 4 that has already been created, the 3D printing apparatus 100 may measure the width of the object 4. Note that the specific processing in step S50 is the one illustrated in FIG. 18.

Once the creation of the first layer 65A is completed, the 3D printing apparatus 100 raises the drive stage 6 in the Z direction in step S51 in order to perform the additive machining of the second layer 65B, which is the next layer. In step S52, the 3D printing apparatus 100 moves the drive stage 6 to position the machining head 2 at the machining point that is the machining position at which the first ball bead 64 is formed. In step S53, the 3D printing apparatus 100 measures the width of the object 4 which is the first layer 65A at the machining position. In step S54, the 3D printing apparatus 100 stores the measurement result of the width of the object 4. The measurement position is the machining position of the ball bead 64 to be formed next.

In step S55, the 3D printing apparatus 100 adjusts machining conditions based on the stored measurement result of the width. The 3D printing apparatus 100 performs additive machining while controlling machining conditions by adjusting machining conditions. In step S56, the 3D printing apparatus 100 determines whether the creation of the m ball beads 64 has been completed in the layer on which the additive machining is currently performed. In response to determining that the creation of the m ball beads 64 has not been completed (step S56: No), the 3D printing apparatus 100 returns the procedure to step S52 to continue creating the ball beads 64 in the layer on which the additive machining is currently performed. The 3D printing apparatus 100 repeats the procedure of steps S52 to S56 until the creation of the ball beads 64 in the layer on which the additive machining is currently performed is completed.

On the other hand, in response to determining that the creation of the m ball beads 64 has been completed (step S56: Yes), the 3D printing apparatus 100 determines in step S57 whether the creation of the n layers has been completed. In response to determining that the creation of the n layers has not been completed (step S57: No), the 3D printing apparatus 100 returns the procedure to step S51 to raise the drive stage 6 in the Z direction and start creating the next layer. The 3D printing apparatus 100 repeats the procedure of steps S51 to S57 until the creation of the n layers is completed.

On the other hand, in response to determining that the creation of the n layers has been completed (step S57: Yes), the 3D printing apparatus 100 ends the formation of the object 4 with the procedure illustrated in FIG. 27. The 3D printing apparatus 100 forms the object 4 that is a final product having a desired shape by creating all the n layers.

As described above, in the steps of measuring the width of the ball bead 64 and controlling machining conditions, the 3D printing apparatus 100 first moves the machining position, specifically moves the machining head 2 in the horizontal direction with respect to the workpiece 3, and measures the bead width at the measurement position which is the machining position before machining. The 3D printing apparatus 100 uses the measurement result of the bead width to control machining conditions for creating the ball bead 64 at the machining position. Once the creation of the ball bead 64 at the machining position is completed, the 3D printing apparatus 100 positions the machining head 2 at the next machining position through the horizontal movement of the drive stage 6. The 3D printing apparatus 100 repeats these steps. Then, once the creation of one layer is completed, the drive stage 6 is raised in the Z direction, and the steps for creating the ball bead 64 are repeated again.

The method of controlling machining conditions using the measurement result of the width of the object 4 in the second embodiment is similar to that in the first embodiment. The control unit 51 controls machining conditions by changing parameters such as the laser output of the machining laser 1, the scanning speed that is the moving speed of the drive stage 6, and the wire feed speed that is the supply speed of the machining material 7, for example. As in the case of the first embodiment, the 3D printing apparatus 100 may measure the width of the object 4 and the height of the object 4, and control machining conditions based on the measurement results of the width of the object 4 and the height of the object 4. As in the case of the first embodiment, the 3D printing apparatus 100 may store the data of bead width and bead height measured for each layer of the object 4, and restore the three-dimensional shape using the stored data after the creation of all the layers is completed.

In the second embodiment, the ball bead 64 has a hemispherical shape, but the ball bead 64 may have a different shape. The ball bead 64 may have any shape as long as the object 4 can be formed by arranging a plurality of beads consisting of a batch of the machining material 7 formed while the drive stage 6 is stationary. For example, the ball bead 64 may be formed in a shape that appears to be a partially-missing circle as viewed from above, in which case the 3D printing apparatus 100 can also perform 3D printing with high accuracy by using the width measurement and the control of machining conditions in the second embodiment. In addition, the ball bead 64 may have a quadrangular shape or the like instead of a circular shape, and there is no problem as long as the bead is formed in a ball shape.

In the second embodiment, the machining position is the center of the ball bead 64, but the 3D printing apparatus 100 can achieve a similar effect even when the machining position is displaced from the center of the ball bead 64. The 3D printing apparatus 100 may create the ball bead 64 by appropriately setting the machining position anywhere other than at the center of the ball bead 64 according to the shape to be created. For example, the machining position may be a joint with the adjacent ball bead 64. In such a case, the bead width is smaller than the width of the center of the ball bead 64. However, as described in the second embodiment, the 3D printing apparatus 100 can perform highly accurate machining by measuring the width of the object 4 already formed at the machining position using the line beam 40 as illumination light, and controlling machining conditions.

Furthermore, in the second embodiment, the width of the already-formed object 4 is measured before one ball bead 64 is formed, additive machining is performed after the measurement, and movement to the next machining point is performed. However, the second embodiment is not limited to this example. For example, the 3D printing apparatus 100 may collectively measure the bead widths of all the beads constituting the (i−1)-th layer after all the additive machining of the (i−1)-th layer is completed, and control the machining conditions for the additive machining of the i-th layer based on the measurement results.

In addition, in the second embodiment, because the 3D printing apparatus 100 moves the machining position in the X direction or the Y direction for depositing, it is not necessary to wait until the melted machining material 7 is completely solidified, and it is possible to measure the height of the completely-solidified beads in the (i−1)-th layer. Therefore, the 3D printing apparatus 100 can achieve both improvement of measurement accuracy and reduction in machining time. In the case of continuous deposition in the Z direction, the 3D printing apparatus 100 measures the width of the object 4 and performs the additive machining of the i-th layer after a lapse of the time required for the beads of the (i−1)-th layer to be completely solidified.

As described above, according to the second embodiment, the 3D printing apparatus 100 can move the machining position, stop the drive stage 6, and measure the bead width at the machining position in a state where machining is not performed, so that the bead width can be measured with high accuracy. The 3D printing apparatus 100 can improve the shape accuracy of the object 4 by optimally controlling machining conditions such that the bead width approaches the target value using the measurement result.

### Third Embodiment

The third embodiment is different from the first or second embodiment in the method of computing the bead width from the cross-sectional height distribution measured in the object 4. The third embodiment is advantageous in measuring the bead width with high accuracy especially when beads are created adjacent to each other. In the third embodiment, components identical to those in the first or second embodiment are denoted by the same reference signs, and configuration differences from the first or second embodiment will be mainly described.

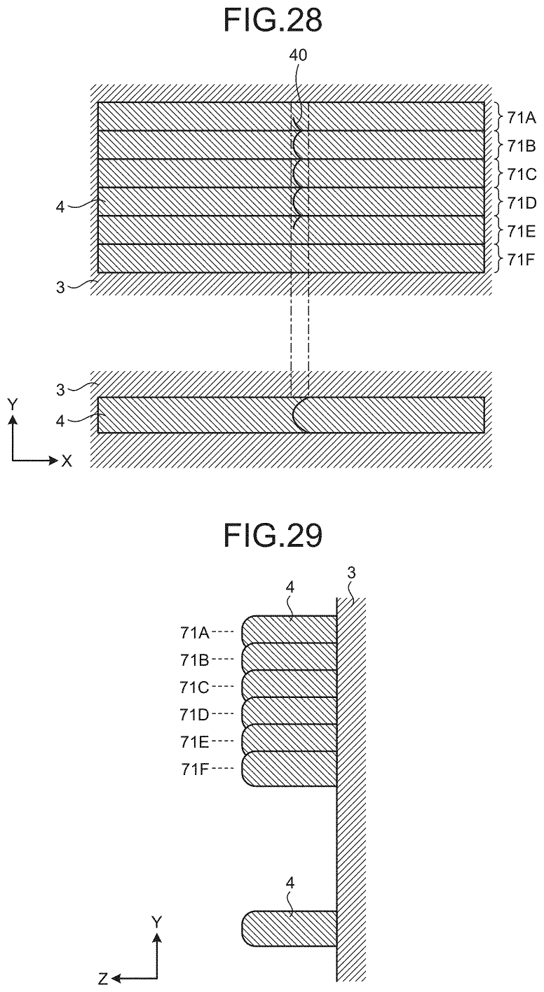

FIG. 28 is a first diagram illustrating an example of the object 4 formed with the 3D printing apparatus 100 according to the third embodiment. FIG. 29 is a second diagram illustrating an example of the object 4 formed with the 3D printing apparatus 100 according to the third embodiment. FIG. 28 shows a state in which the object 4 is viewed in plan view from a position in the +Z direction with respect to the object 4. FIG. 29 shows a state in which the object 4 illustrated in FIG. 28 is viewed in plan view from a position in the +X direction with respect to the object 4.

By arranging a plurality of beads which are line beads described in the first embodiment or ball beads described in the second embodiment adjacent to each other, a shape with a certain area, e.g. a quadrangular prism, may be created as illustrated in FIGS. 28 and 29. Here, suppose that the shape to be created includes six rows of beads. The six rows are adjacent to each other in the Y direction. In each layer, the beads are formed in the order of a first row 71A, a second row 71B, a third row 71C, a fourth row 71D, a fifth row 71E, and a sixth row 71F. FIGS. 28 and 29 show a state in which each row has been created to the i-th layer.

For example, suppose that when the bead of the third row 71C is formed, an attempt is made to compute the bead width of the i-th layer using the cross-sectional height distribution measured by irradiation with the line beam 40 as in the first or second embodiment. In the case where beads are formed adjacent to each other in rows as illustrated in FIGS. 28 and 29, the vertex height of a bead is assumed to be the same as that of a bead formed independently without being adjacent to other beads. On the other hand, in the case where beads are formed adjacent to each other in rows, the height of a bead end in the Y direction is greater than that of a bead formed independently. For example, if the bead of the fourth row 71D is created after the bead of the third row 71C is created, a part of the bead created in the fourth row 71D flows to the third row 71C, which makes the height of the bead end of the third row 71C higher than that of a bead formed independently. Because of the increased height of the bead end, the cross-sectional height distribution in the case that beads are formed adjacent to each other in rows is flatter than that in the case that a bead is formed independently. Therefore, in the case where beads are formed adjacent to each other in rows, it is possible that the boundary points P1 and P2 illustrated in FIGS. 8 and 9 cannot be measured. Therefore, the 3D printing apparatus 100 according to the third embodiment measures the width of the object 4 with the method described below.

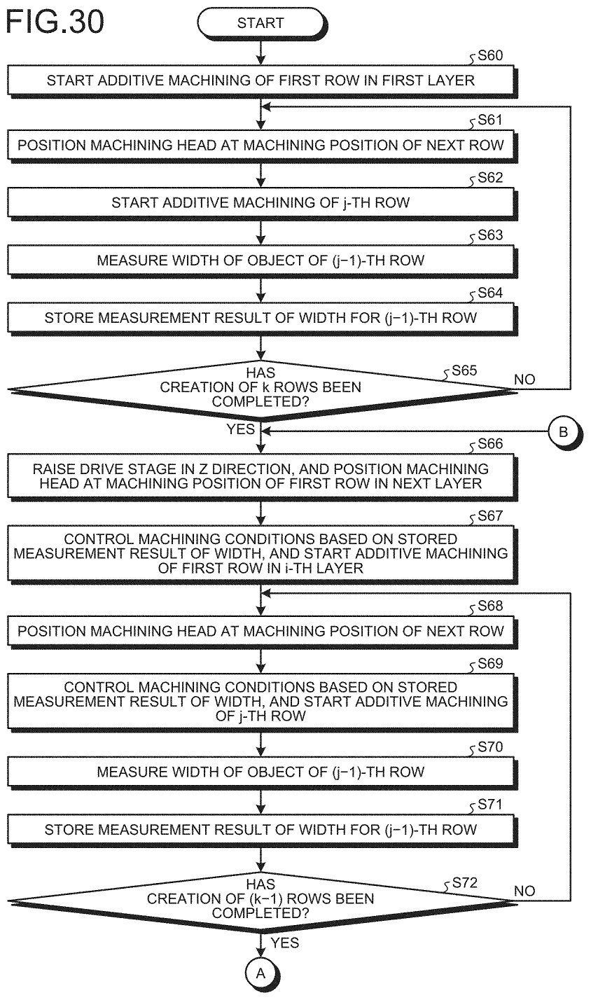

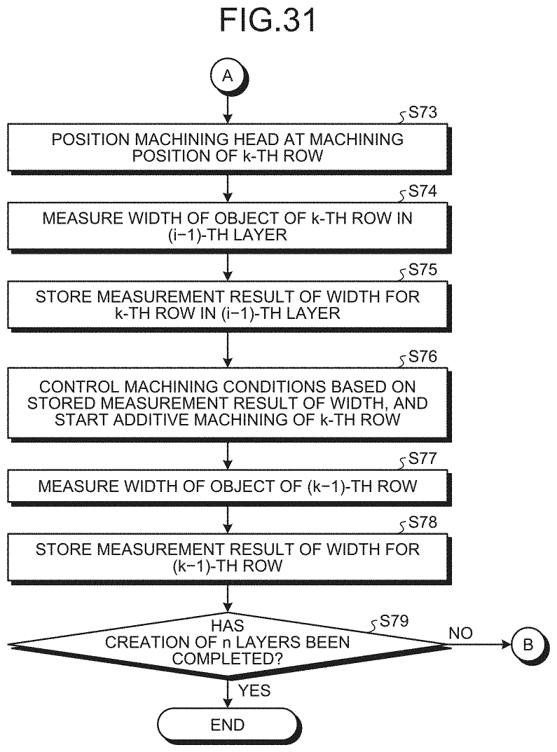

FIGS. 30 and 31 are flowcharts illustrating a procedure for computing the width of the object 4 with the 3D printing apparatus 100 according to the third embodiment. Here, each layer is created by forming a line bead in each of k rows adjacent to each other, and n layers are stacked. Note that k is a freely-determined integer.

First, in step S60, the 3D printing apparatus 100 starts the additive machining of the first row in the first layer. When creating the first row in the first layer, there is no object 4 formed earlier; therefore, the 3D printing apparatus 100 does not measure the width. That is, when creating the first row of the first layer, the 3D printing apparatus 100 skips the step of measuring the width of the object 4.

Once the creation of the first row is completed, the 3D printing apparatus 100 positions the machining head 2 at the machining position of a j-th row, which is the next row, in step S61. Here, j is an integer satisfying 2≤j≤k. In step S62, the 3D printing apparatus 100 starts the additive machining of the j-th row. In step S63, the 3D printing apparatus 100 measures the width of the object 4 of the (j−1)-th row adjacent to the j-th row along with the additive machining. In step S64, the 3D printing apparatus 100 stores the measurement result of the width for the (j−1)-th row.

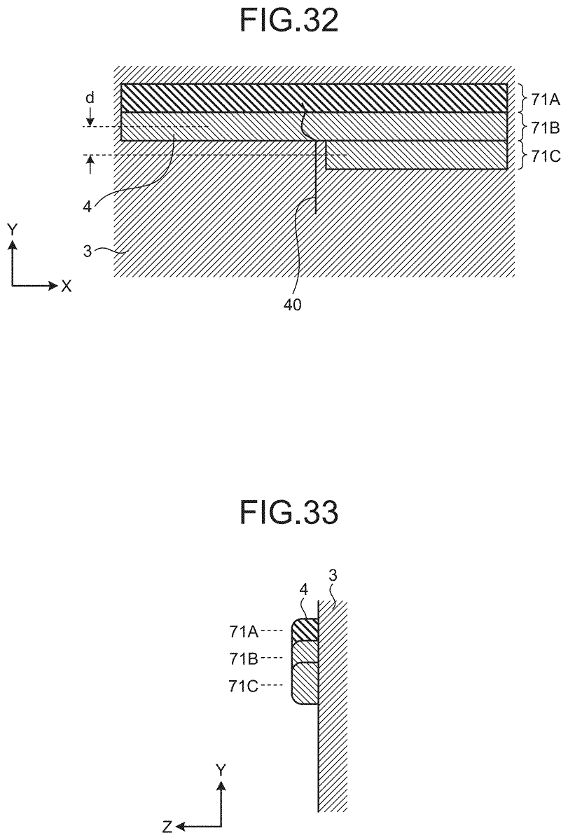

Here, the measurement of the width of the object 4 will be described using a specific example. FIG. 32 is a first diagram for explaining the measurement of the width of the object 4 in the third embodiment. FIG. 33 is a second diagram for explaining the measurement of the width of the object 4 in the third embodiment. FIGS. 32 and 33 show a state in which the bead of the third row 71C illustrated in FIGS. 28 and 29 is formed. In the third embodiment, in a case where a plurality of beads are formed adjacent to each other, the calculation unit 50 computes the width of the object 4 based on the position of one end of beads in the Y direction, which is the third direction, and the distance between the machining centers of the plurality of beads.

The distance between the machining centers of adjacent rows is denoted by d. In step S61, the drive stage 6 moves in the +Y direction by the distance d. While the bead of the third row 71C is formed in step S62, the calculation unit 50 measures the bead width in the (j−1)-th row, namely the second row 71B. Here, the line beam 40 radiated to the second row 71B is spread in the Y direction so that the cross-sectional height distribution of the bead of the second row 71B can be measured. That is, the line beam 40 radiated to the second row 71B crosses at least the first row 71A adjacent to the second row 71B.

As illustrated in FIGS. 32 and 33, in the case where beads are formed in rows sequentially toward the −Y direction, the line beam 40 crosses the first row 71A adjacent to the second row 71B in the +Y direction. Because the end of the second row 71B in the +Y direction overlaps an end of the first row 71A, the position of the end of the second row 71B in the +Y direction cannot be correctly measured.

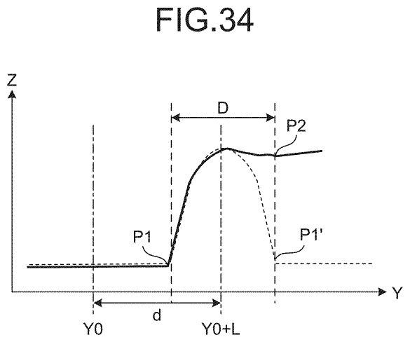

FIG. 34 is a diagram for explaining an example of computing the width of the object 4 from the measurement result of the cross-sectional height distribution of the object 4 in the third embodiment. FIG. 34 shows an example of the cross-sectional height distribution computed from the position of the line beam 40 on the light-receiving element. The position of the current machining center in the Y direction is denoted by Y0. The position of Y0+d in the Y direction is the bead center of the second row 71B adjacent in the +Y direction to the third row 71C currently machined.

The boundary point P1 on the side of the third row 71C as viewed from the bead center, that is, the end in the −Y direction of the bead of the second row 71B, can be measured. On the other hand, the boundary point P2 on the side of the first row 71A as viewed from the bead center, that is, the end in the +Y direction of the bead of the second row 71B, cannot be correctly measured due to the influence of the bead of the first row 71A adjacent to the bead of the second row 71B. In the example illustrated in FIG. 34, the height of the end in the +Y direction of the bead of the second row 71B is close to the height of the vertex of the bead, and the cross-sectional height distribution is flat in the +Y direction from the bead center of the second row 71B. Therefore, it is difficult to identify the boundary point P2. In addition, it is possible that the boundary point P2 can be displaced in the Y direction due to the influence of the flow of molten material between the beads adjacent to each other.

Therefore, in the third embodiment, a position P1′ symmetrical to the boundary point P1 with respect to the bead center Y0+d is regarded as the normal end position of the bead. The calculation unit 50 computes the bead width D based on the relationship of D=P1′−P1=2(Y0+d−P1). With this method, the calculation unit 50 computes the bead width D for each of the k rows except the first row. For the first row, the calculation unit 50 can compute the boundary points P1 and P2 from the cross-sectional height distribution with no need to regard the position P1′ as the end. Thus, the calculation unit 50 can measure the bead width with higher accuracy for the first row.

In step S65, the 3D printing apparatus 100 determines whether the creation of the k rows has been completed for the first layer on which the additive machining is currently performed. In response to determining that the creation of the k rows in the first layer has not been completed (step S65: No), the 3D printing apparatus 100 returns the procedure to step S61 to continue forming the bead of each row in the first layer. The 3D printing apparatus 100 repeats the procedure of steps S61 to S65 until the formation of the bead of each row is completed.

On the other hand, in response to determining that the creation of the k rows in the first layer has been completed (step S65: Yes), the 3D printing apparatus 100 advances the procedure to step S66. In step S66, the 3D printing apparatus 100 raises the drive stage 6 in the Z direction, and positions the machining head 2 at the machining position of the first row in the i-th layer, which is the next layer. Here, the 3D printing apparatus 100 positions the machining head 2 at the machining position of the first row in the second layer next to the first layer.

In step S67, the 3D printing apparatus 100 controls machining conditions based on the stored measurement result of the width, and starts the additive machining of the first row in the i-th layer. The 3D printing apparatus 100 controls the machining conditions for the additive machining of the first row in the i-th layer based on the measurement result for the second row of the (i−1)-th layer. Here, the 3D printing apparatus 100 controls the machining conditions for the additive machining of the first row of the second layer based on the measurement result for the second row of the first layer.

Once the creation of the first row is completed, the 3D printing apparatus 100 positions the machining head 2 at the machining position of the j-th row, which is the next row, in step S68. In step S69, the 3D printing apparatus 100 controls machining conditions based on the stored measurement result of the width, and starts the additive machining of the j-th row. In step S69, the 3D printing apparatus 100 controls machining conditions using the measurement result for the (i−1)-th layer, as in the case of step S67.

In step S70, the 3D printing apparatus 100 measures the width of the object 4 of the (j−1)-th row adjacent to the j-th row as in step S63. In step S71, the 3D printing apparatus 100 stores the measurement result of the width for the (j−1)-th row as in step S64.

In step S72, the 3D printing apparatus 100 determines whether the creation of the (k−1) rows has been completed in the i-th layer. In response to determining that the creation of the (k−1) rows in the i-th layer has not been completed (step S72: No), the 3D printing apparatus 100 returns the procedure to step S68 to continue creating the (k−1) rows in the i-th layer.

On the other hand, in response to determining that the creation of the (k−1) rows in the i-th layer has been completed (step S72: Yes), the 3D printing apparatus 100 advances the procedure to step S73. In step S73, the 3D printing apparatus 100 positions the machining head 2 at the machining position of the k-th row, which is the last row in the i-th layer. Here, by step S73, the width of the object 4 of the k-th row in the (i−1)-th layer has not been measured. Thus, in step S74, the 3D printing apparatus 100 measures the width of the object 4 of the k-th row in the (i−1)-th layer.

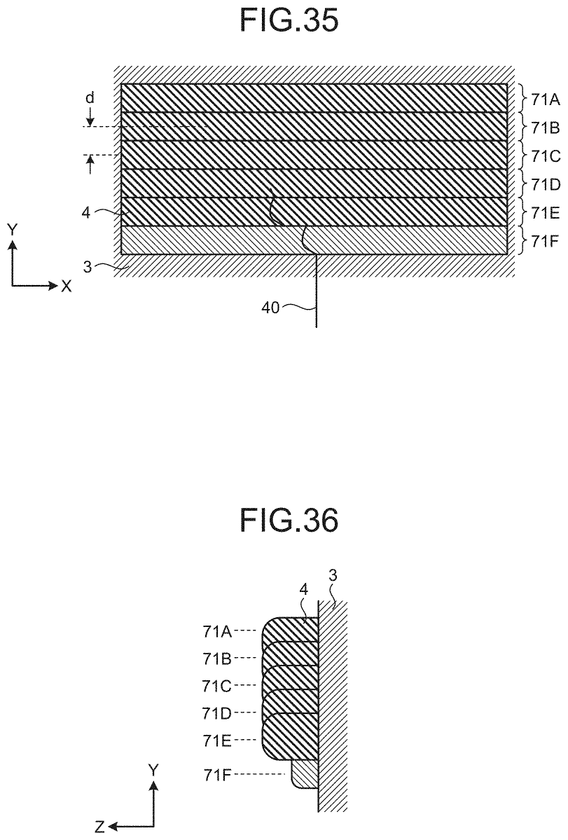

Here, the measurement of the width of the object 4 at the time of creating the last row in one layer will be described using a specific example. FIG. 35 is a first diagram for explaining the measurement of the width of the object 4 at the time of creating the last row in one layer in the third embodiment. FIG. 36 is a second diagram for explaining the measurement of the width of the object 4 at the time of creating the last row in one layer in the third embodiment. FIGS. 35 and 36 show a state in which the bead of the sixth row 71F illustrated in FIGS. 28 and 29 is formed.

By the time the sixth row 71F of the i-th layer is created, the fifth row 71E adjacent to the sixth row 71F has already been created. Therefore, the position of the bead end in the +Y direction of the sixth row 71F of the (i−1)-th layer cannot be accurately measured. However, because there is no bead adjacent in the −Y direction to the sixth row 71F of the (i−1)-th layer, the calculation unit 50 can compute the bead width in the sixth row 71F of the (i−1)-th layer in the same manner as in FIG. 34. Thus, in step S74, the 3D printing apparatus 100 measures the bead width in the row ahead of the current machining position in the layer immediately below the currently created layer. In step S75, the 3D printing apparatus 100 stores the measurement result of the width for the k-th row in the (i−1)-th layer.

In step S76, the 3D printing apparatus 100 controls machining conditions based on the stored measurement result of the width, and starts the additive machining of the k-th row. In step S77, the 3D printing apparatus 100 measures the width of the object 4 of the (k−1)-th row adjacent to the k-th row as in step S70. In step S78, the 3D printing apparatus 100 stores the measurement result of the width for the (k−1)-th row as in step S71.

Once the creation of the k-th row is completed, the 3D printing apparatus 100 determines in step S79 whether the creation of the n layers has been completed. In response to determining that the creation of the n layers has not been completed (step S79: No), the 3D printing apparatus 100 returns the procedure to step S66 to raise the drive stage 6 in the Z direction and start creating the next layer. The 3D printing apparatus 100 repeats the procedure of steps S66 to S79 until the creation of the n layers is completed.

On the other hand, in response to determining that the creation of the n layers has been completed (step S79: Yes), the 3D printing apparatus 100 ends the formation of the object 4 with the procedure illustrated in FIGS. 30 and 31. The 3D printing apparatus 100 forms the object 4 that is a final product having a desired shape by creating all the n layers.

In this manner, the 3D printing apparatus 100 can accurately measure the bead width when beads are formed adjacent to each other. The 3D printing apparatus 100 can improve the creation accuracy by controlling machining conditions such that the bead width approaches the target value using the measurement result of the width. The creation accuracy in the bead width direction is very important especially when creating a large area by arranging a plurality of beads adjacent to each other. Although the third embodiment has described the case where line beads extending in the X direction are arranged adjacent in the Y direction, the manner in which the object 4 is formed may be appropriately changed. For example, the 3D printing apparatus 100 can create line beads extending in the X direction and line beads extending in the Y direction alternately every second layer using a rotation stage, in which case the 3D printing apparatus 100 may measure both the width of the line beads extending in the X direction and the width of the line beads extending in the Y direction, and control machining conditions to form the object 4. In addition, the 3D printing apparatus 100 may form the object 4 by forming ball beads instead of line beads.

In the third embodiment, the position of the end of a bead on the side where a bead adjacent to this bead is present is assumed to be the position P1′ symmetrical to the boundary point P1 with respect to the bead center, but the calculation unit 50 may compute the position of the bead end with other methods. For example, because the bead height can be computed from the cross-sectional height distribution, the calculation unit 50 may compute the position of the bead end on the opposite side of the boundary point P1 by fitting the bead shape based on the bead height and information of the boundary point P1.

For example, as illustrated in FIGS. 32 and 33, in the case where the bead of the second row 71B is longer than the bead of the third row 71C in the X direction, the position of the end of a part of the bead of the second row 71B on the side of the third row 71C cannot be computed while the third row 71C is created. However, if the bead of the second row 71B is longer than both the bead of the first row 71A and the bead of the third row 71C, the bead of the second row 71B can be regarded as a bead formed independently. In this case, the 3D printing apparatus 100 can measure the bead width of the second row 71B ahead of the machining position while the third row 71C is created. In addition, if the bead of the first row 71A is longer than the bead of the third row 71C, the calculation unit 50 can compute, when the second row 71B is created next, the position of the end of the bead cross section of the second row 71B on the side of the third row 71C with the procedure of steps S74 and S75. Thus, the 3D printing apparatus 100 can measure the bead width of the second row 71B.

Although the third embodiment has described the case of creating a quadrangular prism, the 3D printing apparatus 100 can measure the width of the object 4 and optimally control machining conditions when creating any shape including a plurality of beads adjacent to each other, which allows for creation with high accuracy. In addition, although the case of using the three axes of X, Y, and Z has been described here, a similar effect can be achieved in the case of machining using five axes.

The description of the third embodiment assumes that the vertex height of a bead adjacent to another bead is the same as the vertex height of a bead formed independently without being adjacent to another bead. There is no problem in assuming that the vertex height of a bead adjacent to another bead is different from that of a bead formed independently. In the third embodiment, as illustrated in FIG. 34, the calculation unit 50 computes the bead width by measuring the boundary point P1 on the side where no adjacent bead is formed, among the two boundary points P1 and P2. Therefore, even when the vertex height of a bead is different from that of a bead formed independently, the calculation unit 50 can compute the bead width.

The first to third embodiments have described the method of measuring the cross-sectional height distribution of the object 4 by measuring the position of the line beam 40 at the light-receiving element using the line beam 40, but the present disclosure is not limited to this method. A similar effect can be achieved as long as the 3D printing apparatus 100 includes the measurement illumination unit 8 and the light-receiving optical system and is configured to be capable of measuring the cross-sectional height distribution of the object 4. The first to third embodiments have shown the configuration in which the objective lens 13 of the machining optical system is shared by the light-receiving optical system or the illumination optical system. Here, the term “shared” just means that light rays passing through different optical systems go through one lens. The first to third embodiments have described the method of computing the width of the object 4 from the cross-sectional height distribution, but the present disclosure is not limited to this method. The 3D printing apparatus 100 only needs to measure the height of the object 4 and measure the width of the object 4 based on the height information.

The configurations described in the above-mentioned embodiments indicate examples of the contents of the present disclosure. The configurations of the embodiments can be combined with another well-known technique. The configurations of the embodiments may be combined with each other as appropriate. Some of the configurations of the embodiments can be omitted or changed without departing from the gist of the present disclosure.

### REFERENCE SIGNS LIST

1 machining laser; 2 machining head; 3 workpiece; 4 object; 5 fixture; 6 drive stage; 7 machining material; 8 measurement illumination unit; 9 gas nozzle; 10 machining material supply unit; 11 light-projecting lens; 12 beam splitter; 13 objective lens; 14 bandpass filter; 15 condenser lens; 16 light receiver; 17 light-receiving unit; 30 beam; 31, 62 melt pool; 32 high-temperature portion; 33 center; 35 bead; 40, 41, 42, 46 line beam; 43 measurement position; 44 reference pixel position; 45 visual field; 50 calculation unit; 51 control unit; 61 target surface; 63 molten bead; 64 ball bead; 65A first layer; 65B second layer; 65C third layer; 71A first row; 71B second row; 71C third row; 71D fourth row; 71E fifth row; 71F sixth row; 100, 101 3D printing apparatus; 200 control circuit; 200a processor; 200b memory; AR machining area; CL optical axis; CW central axis.

1. A 3D printing apparatus that forms an object by radiating machining light to a machining material supplied to a machining position to melt the machining material, and stacking, on a workpiece, beads that are solidified products of the machining material melted, the 3D printing apparatus comprising:
a machining optical system including an objective lens through which the machining light passes, and configured to radiate the machining light to the machining position;
a measurement illuminator to supply illumination light for measuring a size of the object formed;
a light-receiving element to detect reflected light that is the illumination light reflected by the object;
a light-receiving optical system to concentrate the reflected light on the light-receiving element;
a calculation circuitry to compute, through calculation using a detection result of the reflected light in the light-receiving element, a width of the object in a third direction perpendicular to a first direction in which the machining position is moved with respect to the workpiece and a second direction in which the beads are stacked; and
a control circuitry to control a machining condition for forming the beads based on a computation result of the width of the object, wherein
the calculation circuitry computes a cross-sectional height distribution of the object based on the detection result of the reflected light, and computes the width of the object based on the cross-sectional height distribution.

2. The 3D printing apparatus according to claim 1, wherein the illumination light is a line beam radiated linearly.

3. (canceled)

4. The 3D printing apparatus according to claim 2, wherein a position of the measurement illuminator is movable such that a longitudinal direction of the line beam is perpendicular to a machining path.

5. The 3D printing apparatus according to claim 2, wherein
an optical axis of the line beam is inclined with respect to an optical axis of the light-receiving optical system, and
the line beam is uninterruptedly radiated in an angular range of at least ±90 degrees around the optical axis of the light-receiving optical system and relative to a direction counter to a direction in which the machining material is supplied.

6. The 3D printing apparatus according to claim 1, wherein the illumination light is a line beam radiated in a circular shape.

7. The 3D printing apparatus according to claim 1, wherein
the measurement illuminator radiates the illumination light toward a measurement position on the workpiece or on the object formed, and
the measurement position is a position where the machining material melted is solidified, and the measurement position moves as the machining position moves.

8. (canceled)

9. The 3D printing apparatus according to claim 7, wherein the measurement position is a position in a same direction, relative to the machining position, as a direction in which the machining position moves on the workpiece.

10. The 3D printing apparatus according to claim 1, wherein
the calculation circuitry measures the width of the object at each of a plurality of the machining positions, and
the control circuitry controls the machining condition at each of the plurality of machining positions based on a measurement result of the width of the object.

11.-13. (canceled)

14. The 3D printing apparatus according to claim 1, wherein the calculation circuitry measures the width of the object by estimating a shape of the beads based on a position of one end of the beads in the third direction and a measurement result of the height of the object.

15. The 3D printing apparatus according to claim 1, wherein the control circuitry controls the machining condition to bring the width of the object to be formed close to a target value indicating the width of a designed shape.

16. The 3D printing apparatus according to claim 1, wherein the control circuitry controls the machining condition to bring the width of the object to be formed close to a target value indicating the width of a designed shape, and to bring the height of the object to be formed close to a target value indicating the height of the designed shape.

17. The 3D printing apparatus according to claim 1, wherein the calculation circuitry stores data of bead width and bead height measured for each layer of the object, and restores a three-dimensional shape of the object using the data stored.

18. The 3D printing apparatus according to claim 1, wherein the control circuitry reduces output of the machining light when the width of the object measured is greater than a preset target value, and increases the output of the machining light when the width of the object measured is smaller than the preset target value.

19. The 3D printing apparatus according to claim 1, wherein the control circuitry increases a speed at which the machining position is moved when the width of the object measured is greater than a preset target value, and reduces the speed at which the machining position is moved when the width of the object measured is smaller than the preset target value.

20. The 3D printing apparatus according to claim 1, wherein the control circuitry reduces a supply speed of the machining material when the width of the object measured is greater than a preset target value, and increases the supply speed of the machining material when the width of the object measured is smaller than the preset target value.

21. (canceled)

22. The 3D printing apparatus according to claim 1, wherein the calculation circuitry computes the width of the object by computing a position of an end of the object based on the cross-sectional height distribution.

23. The 3D printing apparatus according to claim 1, wherein in a case where a plurality of the beads are formed adjacent to each other, the calculation circuitry computes the width of the object based on a position of one end of the beads in the third direction and a distance between machining centers of the plurality of beads.
